(19) United States
(12) Patent Application Publication
(10) Pub. No.: US 2017/0163293 A1
(43) Pub. Date: Jun. 8, 2017

(54) ELECTRONIC DEVICE INCLUDING SINGLE ANTENNA SUPPORTING MULTIPLE COMMUNICATION PROTOCOLS AND OPERATING METHOD THEREOF

(71) Applicant: Samsung Electronics Co., Ltd, Gyeonggi-do (KR)

(72) Inventors: Jeongheum Lee, Gyeonggi-do (KR); Yong-Suk Lee, Seoul (KR)

(21) Appl. No.: 15/368,567

(22) Filed: Dec. 2, 2016

(30) Foreign Application Priority Data
Dec. 4, 2015 (KR) 10-2015-0172267

(51) Int. Cl. H04B 1/00; H04W 88/06; H04B 7/08

(52) U.S. Cl. CPC H04B 1/0057; H04B 7/0871; H04W 88/06; H04L 69/18

(57) ABSTRACT

An electronic device includes a first communication circuit including a first port and a second port, the first port being used to transmit and receive a first signal of a first frequency band and the second port being used to transmit and receive a second signal of a second frequency band lower than the first frequency band, a second communication circuit including a third port used to transmit and receive a third signal of a third frequency band that is at least partially overlapping the first frequency band, and a first diplexer including three terminals, the first terminal being connected with the first antenna, the second terminal being connected with the second port of the first communication circuit, and the third terminal being connected with the first port of the first communication circuit and the third port of the second communication circuit through at least one first signal divider/signal combiner.

### CROSS-REFERENCE TO RELATED APPLICATION(S) AND CLAIM OF PRIORITY

The present application is related to and claims the priority under 35 U.S.C. §119(a) to Korean Application Serial No. 10-2015-0172267, which was filed in the Korean Intellectual Property Office on Dec. 4, 2015, the entire content of which is hereby incorporated by reference.

### TECHNICAL FIELD

Various embodiments of the present disclosure relate to an electronic device, and more particularly, to an electronic device and an operating method thereof, the electronic device including a single antenna that supports multiple communication protocols.

### BACKGROUND

Recently, electronic devices have developed into various forms of devices, such as portable devices (e.g., smart phones, tablet PCs, and the like.) and wearable devices (e.g., smart watches, head mounted devices, and the like.). These various forms of electronic devices may include an antenna for a global positioning system (GPS) and one or more antennas for 2G, 3G, and 4G communication schemes in order to provide various communication services and additional functions. For example, an electronic device may include a global system for mobile telecommunication (GSM) antenna, a long term evolution (LTE) antenna, a wireless LAN (or Wi-Fi) antenna, etc.

As described above, an electronic device may require antennas for respective communication schemes in order to support various communication services. Accordingly, when a communication service based on a novel communication protocol is added to the electronic device, the number of antennas may increase. In particular, when the electronic device includes a diversity antenna, the number of antennas required may double.

### SUMMARY

To address the above-discussed deficiencies, it is a primary object to provide an electronic device and an operating method thereof, the electronic device including a single antenna that supports a plurality of different communication protocols.

Various embodiments of the present disclosure may provide a device and method for reducing the complexity of switch control for antenna sharing in an electronic device.

Various embodiments of the present disclosure may provide a device and method for reducing the number of switch control interfaces for antenna sharing in an electronic device.

Various embodiments of the present disclosure may provide a device and method for reducing the complexity of a scan algorithm for the coexistence of two different communication protocols in an electronic device.

According to various embodiments of the present disclosure, an electronic device may include a housing, a first antenna configured to form a first portion of the housing or located in the housing so as to be adjacent to the first portion of the housing, a first communication circuit that includes a first port and a second port, the first port being used to transmit and/or receive a first signal of a first frequency band and the second port being used to transmit and/or receive a second signal of a second frequency band lower than the first frequency band, a second communication circuit that includes a third port used to transmit and/or receive a third signal of a third frequency band at least partially overlapping the first frequency band, and a first diplexer that includes first to third terminals, the first terminal being electrically connected with the first antenna, the second terminal being electrically connected with the second port of the first communication circuit, and the third terminal being electrically connected with the first port of the first communication circuit and the third port of the second communication circuit through at least one first signal divider/signal combiner.

According to various embodiments of the present disclosure, an electronic device may include an antenna configured to receive, through a first antenna, at least one of a signal of a first frequency band corresponding to a first communication protocol and a signal of a second frequency band at least partially overlapping the first frequency band and corresponding to a second communication protocol, a signal divider configured to divide one of the signal of the first frequency band and the signal of the second frequency band into two paths; a first communication processor configured to decode the signals divided from each other on the basis of the first communication protocol, and a second communication processor configured to decode the signals divided from each other on the basis of the second communication protocol.

According to various embodiments of the present disclosure, an operating method for an electronic device may include receiving, through a first antenna, at least one of a signal of a first frequency band corresponding to a first communication protocol and a signal of a second frequency band at least partially overlapping the first frequency band and corresponding to a second communication protocol, dividing at least one of the signal of the first frequency band and the signal of the second frequency band into two paths, decoding the signals divided from each other on the basis of the first communication protocol, and decoding the signals divided from each other on the basis of the second communication protocol.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment that includes an electronic device according to one embodiment of the present disclosure;

FIG. 2 illustrates an electronic device according to various embodiments of the present disclosure;

FIG. 3 illustrates a program module according to various embodiments of the present disclosure;

FIG. 4 illustrates a network environment that includes an electronic device using two different communication protocols in the same band according to various embodiments of the present disclosure;

FIG. 5 is a perspective view illustrating the electronic device that includes a housing according to various embodiments of the present disclosure;

FIG. 6 illustrates channelization used by Wi-Fi of the 5 GHz band according to various embodiments of the present disclosure;

FIG. 7 illustrates channelization used by LTE of the 5 GHz band according to various embodiments of the present disclosure;

FIGS. 8A and 8B are block diagrams of electronic devices according to various embodiments of the present disclosure;

FIGS. 9A and 9B are block diagrams of electronic devices according to various embodiments of the present disclosure;

FIG. 10 is a block diagram of an electronic device according to an embodiment of the present disclosure;

FIG. 11 illustrates a diplexer of an electronic device according to an embodiment of the present disclosure;

FIG. 12A illustrates signal divider of an electronic device according to an embodiment of the present disclosure;

FIG. 12B illustrates a signal combiner of an electronic device according to an embodiment of the present disclosure;

FIG. 13A illustrates a coupler of a signal divider according to an embodiment of the present disclosure;

FIG. 13B illustrates a coupler of a signal combiner according to an embodiment of the present disclosure;

FIG. 14 is a flowchart for an antenna operation of an electronic device according to an embodiment of the present disclosure;

FIG. 15 is a flowchart illustrating the operation of a signal divider of an electronic device according to an embodiment of the present disclosure;

FIG. 16 is a flowchart illustrating the operation of a signal combiner of an electronic device according to an embodiment of the present disclosure;

FIG. 17 is a flowchart illustrating a receiving operation of an electronic device according to an embodiment of the present disclosure; and

FIG. 18 is a flowchart illustrating a transmitting operation of an electronic device according to an embodiment of the present disclosure.

### DETAILED DESCRIPTION

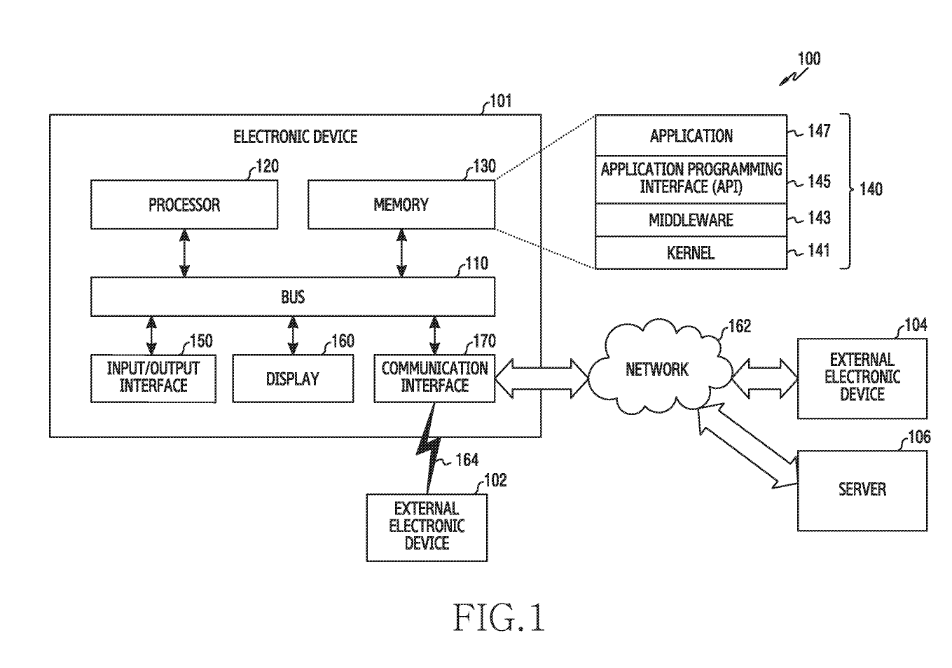

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including both at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV®), a game console (e.g., Xbox® and PlayStation®), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

FIG. 1 illustrates a network environment including an electronic device according to various embodiments of the present disclosure.

An electronic device 101 within a network environment 100, according to various embodiments, will be described with reference to FIG. 1. The electronic device 101 can include a bus 110, a processor 120, a memory 130, an input/output interface 150, a display 160, and a communication interface 170. In some embodiments, the electronic device 101 can omit at least one of the above elements or can further include other elements.

The bus 110 can include, for example, a circuit for connecting the elements 110-170 and transferring communication (e.g., control messages and/or data) between the elements.

The processor 120 can include one or more of a Central Processing Unit (CPU), an Application Processor (AP), and a Communication Processor (CP). The processor 120, for example, can carry out operations or data processing relating to control and/or communication of at least one other element of the electronic device 101.

The memory 130 can include a volatile memory and/or a non-volatile memory. The memory 130 can store, for example, instructions or data relevant to at least one other element of the electronic device 101. According to an embodiment, the memory 130 can store software and/or a program 140. The program 140 can include, for example, a kernel 141, middleware 143, an Application Programming Interface (API) 145, and/or application programs (or “applications”) 147. At least some of the kernel 141, the middleware 143, and the API 145 can be referred to as an Operating System (OS).

The kernel 141 can control or manage system resources (e.g., the bus 110, the processor 120, or the memory 130) used for performing an operation or function implemented by the other programs (e.g., the middleware 143, the API 145, or the application programs 147). Furthermore, the kernel 141 can provide an interface through which the middleware 143, the API 145, or the application programs 147 can access the individual elements of the electronic device 101 to control or manage the system resources.

The middleware 143, for example, can function as an intermediary for allowing the API 145 or the application programs 147 to communicate with the kernel 141 to exchange data.

In addition, the middleware 143 can process one or more operation requests received from the application program 147 according to priority. For example, the middleware 143 can give priority to use the system resources of the electronic device 101 (for example, the bus 110, the processor 120, the memory 130, and the like) to at least one of the application programs 147. For example, the middleware 143 can perform scheduling or load balancing with respect to the one or more operation requests by processing the one or more operation requests according to the priority given to the at least one application program.

The API 145 is an interface through which the applications 147 control functions provided from the kernel 141 or the middleware 143, and can include, for example, at least one interface or function (e.g., instruction) for file control, window control, image processing, or text control.

The input/output interface 150, for example, can function as an interface that can transfer instructions or data input from a user or another external device to the other element(s) of the electronic device 101. Furthermore, the input/output interface 150 can output the instructions or data received from the other element(s) of the electronic device 101 to the user or another external device.

The display 160 can include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160, for example, can display various types of content (e.g., text, images, videos, icons, or symbols) for the user. The display 160 can include a touch screen and receive, for example, a touch, gesture, proximity, or hovering input using an electronic pen or the user's body part.

The communication interface 170, for example, can set communication between the electronic device 101 and an external device (e.g., the first external electronic device 102, the second external electronic device 104, or a server 106). For example, the communication interface 170 can be connected to a network 162 through wireless or wired communication to communicate with the external device (e.g., the second external electronic device 104 or the server 106).

The wireless communication can use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication can include, for example, short range communication 164. The short-range communication 164 can be performed by using at least one of, for example, Wi-Fi, Bluetooth, Bluetooth low energy (BLE), Near Field Communication (NFC), and Global Navigation Satellite System (GNSS). The GNSS can include at least one of, for example, a Global Positioning System (GPS), a Global Navigation Satellite System (Glonass), a Beidou Navigation Satellite System (hereinafter referred to as “Beidou”), and a European Global Satellite-based Navigation System (Galileo), according to a use area, a bandwidth, or the like. Hereinafter, in the present disclosure, the “GPS” can be interchangeably used with the “GNSS”. The wired communication can include at least one of, for example, a Universal Serial Bus (USB), a High Definition Multimedia Interface (HDMI), Recommended Standard 232 (RS-232), and a Plain Old Telephone Service (POTS). The network 162 can include at least one of a communication network such as a computer network (e.g., a LAN or a WAN), the Internet, and a telephone network.

Each of the first and second external electronic apparatuses 102 and 104 can be of a type identical to or different from that of the electronic apparatus 101. According to an embodiment, the server 106 can include a group of one or more servers. According to various embodiments, all or some of the operations performed in the electronic device 101 can be performed in another electronic device or a plurality of electronic devices (e.g., the electronic devices 102 and 104 or the server 106). According to an embodiment, when the electronic device 101 has to perform some functions or services automatically or in response to a request, the electronic device 101 can make a request for performing at least some functions relating thereto to another device (e.g., the electronic device 102 or 104 or the server 106) instead of performing the functions or services by itself or in addition. Another electronic apparatus can execute the requested functions or the additional functions, and can deliver a result of the execution to the electronic apparatus 101. The electronic device 101 can process the received result as it is or additionally to provide the requested functions or services. To achieve this, for example, cloud computing, distributed computing, or client-server computing technology can be used.

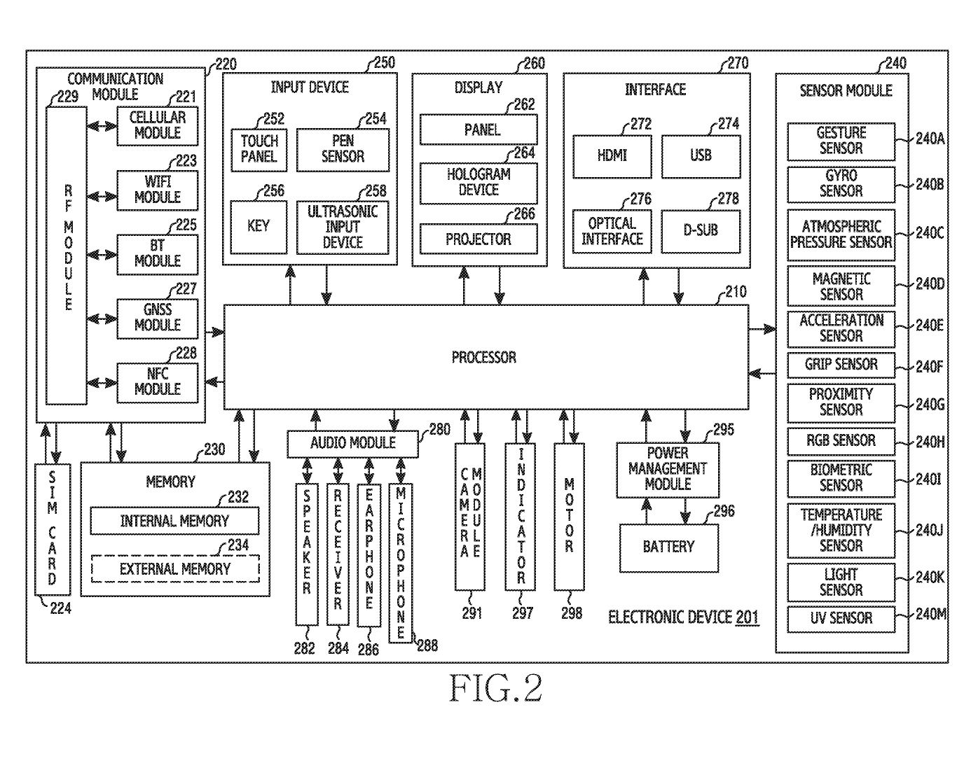

FIG. 2 is a block diagram illustrating an electronic device according to various embodiments of the present disclosure.

FIG. 2 is a block diagram of an electronic device 201 according to various embodiments. For example, the electronic apparatus 201 can include the whole or part of the electronic apparatus 101 illustrated in FIG. 1. The electronic device 201 can include at least one processor (e.g., Application Processor (AP)) 210, a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 can control a plurality of hardware or software components connected to the processor 210 by driving an operating system or an application program and perform processing of various pieces of data and calculations. The processor 210 can be implemented by, for example, a System on Chip (SoC). According to an embodiment, the processor 210 can further include a Graphic Processing Unit (GPU) and/or an image signal processor. The processor 210 can include at least some (e.g., a cellular module 221) of the elements illustrated in FIG. 2. The processor 210 can load, into a volatile memory, instructions or data received from at least one (e.g., a non-volatile memory) of the other elements and can process the loaded instructions or data, and can store various data in a non-volatile memory.

The communication module 220 can have a configuration equal or similar to that of the communication interface 170 of FIG. 1. The communication module 220 can include, for example, the cellular module 221, a Wi-Fi module 223, a Bluetooth (BT) module 225, a GNSS module 227 (e.g., a GPS module, a Glonass module, a Beidou module, or a Galileo module), an NFC module 228, and a Radio Frequency (RF) module 229.

The cellular module 221 can provide a voice call, image call, a text message service, or an Internet service through, for example, a communication network. According to an embodiment, the cellular module 221 can distinguish between and authenticate electronic devices 201 within a communication network using a subscriber identification module (for example, the SIM card 224). According to an embodiment of the present disclosure, the cellular module 221 can perform at least some of the functions that the processor 210 can provide. According to an embodiment, the cellular module 221 can include a Communication Processor (CP).

Each of the Wi-Fi module 223, the BT module 225, the GNSS module 227, and the NFC module 228 can include, for example, a processor for processing data transmitted and received through the relevant module. According to some embodiments of the present disclosure, at least some (e.g., two or more) of the cellular module 221, the Wi-Fi module 223, the BT module 225, the GNSS module 227, and the NFC module 228 can be included in one Integrated Chip (IC) or IC package.

The RF module 229 can transmit/receive, for example, a communication signal (for example, an RF signal). The RF module 229 can include, for example, a transceiver, a Power Amplifier Module (PAM), a frequency filter, a Low Noise Amplifier (LNA), and an antenna. According to another embodiment of the present disclosure, at least one of the cellular module 221, the Wi-Fi module 223, the BT module 225, the GNSS module 227, and the NFC module 228 can transmit and receive RF signals through a separate RF module.

The subscriber identification module 224 can include, for example, a card including a subscriber identity module and/or an embedded SIM, and can contain unique identification information (e.g., an Integrated Circuit Card Identifier (ICCID)) or subscriber information (e.g., an International Mobile Subscriber Identity (IMSI)).

The memory 230 (for example, the memory 130) can include, for example, an internal memory 232 or an external memory 234. The embedded memory 232 can include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disc drive, a Solid State Drive (SSD), and the like).

The external memory 234 can further include a flash drive, for example, a Compact Flash (CF), a Secure Digital (SD), a Micro Secure Digital (Micro-SD), a Mini Secure Digital (Mini-SD), an eXtreme Digital (xD), a memory stick, or the like. The external memory 234 can be functionally and/or physically connected to the electronic apparatus 201 through various interfaces.

The sensor module 240 can measure a physical quantity or detect an operation state of the electronic device 201, and can convert the measured or detected information into an electrical signal. For example, the sensor module 240 can include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a Red/Green/Blue (RGB) sensor), a bio-sensor 2401, a temperature/humidity sensor 240J, a light sensor 240K, and an Ultra Violet (UV) sensor 240M. Additionally or alternatively, the sensor module 240 can include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 can further include a control circuit for controlling one or more sensors included therein. In some embodiments of the present disclosure, the electronic apparatus 201 can further include a processor configured to control the sensor module 240 as a part of or separately from the processor 210, and can control the sensor module 240 while the processor 210 is in a sleep state.

The input device 250 can include, for example, a touch panel 252, a (digital) pen sensor 254, a key 256, or an ultrasonic input device 258. The touch panel 252 can use at least one of, for example, a capacitive type, a resistive type, an infrared type, and an ultrasonic type. Also, the touch panel 252 can further include a control circuit. The touch panel 252 can further include a tactile layer and provide a tactile reaction to the user.

The (digital) pen sensor 254 can include, for example, a recognition sheet which is a part of the touch panel or is separated from the touch panel. The key 256 can include, for example, a physical button, an optical key or a keypad. The ultrasonic input device 258 can detect ultrasonic wavers generated by an input tool through a microphone (for example, a microphone 288) and identify data corresponding to the detected ultrasonic waves.

The display 260 (for example, the display 160) can include a panel 262, a hologram device 264 or a projector 266. The panel 262 can include a configuration that is identical or similar to the display 160 illustrated in FIG. 1. The panel 262 can be implemented to be, for example, flexible, transparent, or wearable. The panel 262 and the touch panel 252 can be implemented as one module. The hologram 264 can show a three dimensional image in the air by using an interference of light. The projector 266 can display an image by projecting light onto a screen. The screen can be located, for example, inside or outside the electronic apparatus 201. According to an embodiment, the display 260 can further include a control circuit for controlling the panel 262, the hologram device 264, or the projector 266.

The interface 270 can include, for example, a High-Definition Multimedia Interface (HDMI) 272, a Universal Serial Bus (USB) 274, an optical interface 276, or a D-subminiature (D-sub) 278. The interface 270 can be included in, for example, the communication interface 170 illustrated in FIG. 1. Additionally or alternatively, the interface 270 can include, for example, a Mobile High-definition Link (MHL) interface, a Secure Digital (SD) card/Multi-Media Card (MMC) interface, or an Infrared Data Association (IrDA) standard interface.

The audio module 280 can bilaterally convert, for example, a sound and an electrical signal. At least some elements of the audio module 280 can be included in, for example, the input/output interface 145 illustrated in FIG. 1. The audio module 280 can process sound information which is input or output through, for example, a speaker 282, a receiver 284, earphones 286, the microphone 288 or the like.

The camera module 291 is a device which can photograph a still image and a dynamic image. According to an embodiment, the camera module 291 can include one or more image sensors (for example, a front sensor or a back sensor), a lens, an Image Signal Processor (ISP) or a flash (for example, LED or xenon lamp).

The power management module 295 can manage, for example, power of the electronic device 201. According to an embodiment, the power management module 295 can include a Power Management Integrated Circuit (PMIC), a charger Integrated Circuit (IC), or a battery or fuel gauge. The PMIC can use a wired and/or wireless charging method. Examples of the wireless charging method can include, for example, a magnetic resonance method, a magnetic induction method, an electromagnetic method, and the like. Additional circuits (e.g., a coil loop, a resonance circuit, a rectifier, etc.) for wireless charging can be further included. The battery gauge can measure, for example, a residual quantity of the battery 296, and a voltage, a current, or a temperature during the charging. The battery 296 can include, for example, a rechargeable battery or a solar battery.

The indicator 297 can display a particular state (e.g., a booting state, a message state, a charging state, or the like) of the electronic apparatus 201 or a part (e.g., the processor 210). The motor 298 can convert an electrical signal into mechanical vibration, and can generate vibration, a haptic effect, or the like. Although not illustrated, the electronic apparatus 201 can include a processing unit (e.g., a GPU) for supporting a mobile television (TV). The processing unit for supporting mobile TV can, for example, process media data according to a certain standard such as Digital Multimedia Broadcasting (DMB), Digital Video Broadcasting (DVB), or mediaFLO™

Each of the above-described component elements of hardware according to the present disclosure can be configured with one or more components, and the names of the corresponding component elements can vary based on the type of electronic device. The electronic device according to various embodiments of the present disclosure can include at least one of the aforementioned elements. Some elements can be omitted or other additional elements can be further included in the electronic device. Also, some of the hardware components according to various embodiments can be combined into one entity, which can perform functions identical to those of the relevant components before the combination.

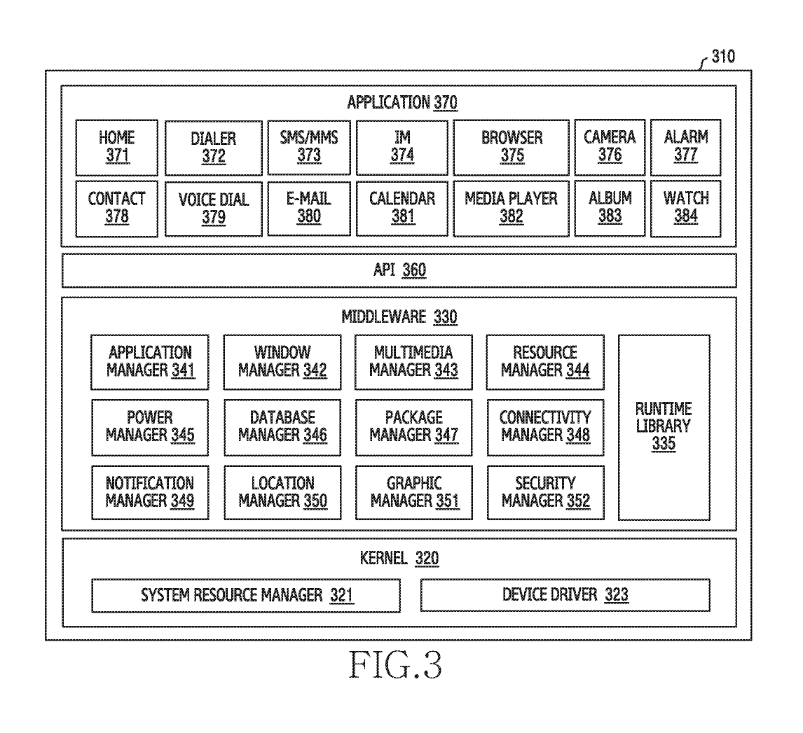

FIG. 3 is a block diagram of a program module according to various embodiments of the present disclosure.

According to an embodiment, the program module 310 (for example, the program 140) can include an Operating System (OS) for controlling resources related to the electronic device (for example, the electronic device 101) and/or various applications (for example, the application programs 147) executed in the operating system. The operating system can be, for example, Android, iOS, Windows, Symbian, Tizen, Bada, or the like.

The program module 310 can include a kernel 320, middleware 330, an API 360, and/or an application 370. At least some of the program module 310 can be preloaded on the electronic apparatus, or can be downloaded from an external electronic apparatus (e.g., the electronic apparatus 102 or 104, or the server 106).

The kernel 320 (e.g., the kernel 141) can include, for example, a system resource manager 321 and/or a device driver 323. The system resource manager 321 can perform the control, allocation, retrieval, or the like of system resources. According to an embodiment of the present disclosure, the system resource manager 321 can include a process manager, a memory manager, a file system manager, or the like. The device driver 323 can include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 can provide a function required by the applications 370 in common or provide various functions to the applications 370 through the API 360 so that the applications 370 can efficiently use limited system resources within the electronic device. According to an embodiment, the middleware 330 (for example, the middleware 143) can include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 can include a library module that a compiler uses in order to add a new function through a programming language while the applications 370 are being executed. The runtime library 335 can perform input/output management, memory management, the functionality for an arithmetic function, or the like.

The application manager 341 can manage, for example, the life cycle of at least one of the applications 370. The window manager 342 can manage Graphical User Interface (GUI) resources used for the screen. The multimedia manager 343 can determine a format required to reproduce various media files, and can encode or decode a media file by using a coder/decoder (codec) appropriate for the relevant format. The resource manager 344 can manage resources, such as a source code, a memory, a storage space, and the like of at least one of the applications 370.

The power manager 345 can operate together with a Basic Input/Output System (BIOS) to manage a battery or power and can provide power information required for the operation of the electronic device. The database manager 346 can generate, search for, and/or change a database to be used by at least one of the applications 370. The package manager 347 can manage the installation or update of an application distributed in the form of a package file.

The connectivity manager 348 can manage a wireless connection such as, for example, Wi-Fi or Bluetooth. The notification manager 349 can display or notify of an event, such as an arrival message, an appointment, a proximity notification, and the like, in such a manner as not to disturb the user. The location manager 350 can manage location information of the electronic apparatus. The graphic manager 351 can manage a graphic effect, which is to be provided to the user, or a user interface related to the graphic effect. The security manager 352 can provide various security functions required for system security, user authentication, and the like. According to an embodiment of the present disclosure, when the electronic apparatus (e.g., the electronic apparatus 101) has a telephone call function, the middleware 330 can further include a telephony manager for managing a voice call function or a video call function of the electronic apparatus.

The middleware 330 can include a middleware module that forms a combination of various functions of the above-described elements. The middleware 330 can provide a module specialized for each type of OS in order to provide a differentiated function. Also, the middleware 330 can dynamically delete some of the existing elements, or can add new elements.

The API 360 (e.g., the API 145) is, for example, a set of API programming functions, and can be provided with a different configuration according to an OS. For example, in the case of Android or iOS, one API set can be provided for each platform. In the case of Tizen, two or more API sets can be provided for each platform.

The applications 370 (for example, the application program 147) can include, for example, one or more applications which can provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to an embodiment of the present disclosure, the applications 370 can include an application (hereinafter, referred to as an “information exchange application” for convenience of description) supporting information exchange between the electronic apparatus (e.g., the electronic apparatus 101) and an external electronic apparatus (e.g., the electronic apparatus 102 or 104). The application associated with information exchange can include, for example, a notification relay application for forwarding specific information to an external electronic device, or a device management application for managing an external electronic device.

For example, the notification relay application can include a function of delivering, to the external electronic apparatus (e.g., the electronic apparatus 102 or 104), notification information generated by other applications (e.g., an SMS/MMS application, an email application, a health care application, an environmental information application, etc.) of the electronic apparatus 101. Further, the notification relay application can receive notification information from, for example, an external electronic device and provide the received notification information to a user.

The device management application can manage (for example, install, delete, or update), for example, a function for at least a part of the external electronic device (for example, the electronic device 102 or 104) communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment, the applications 370 can include applications (for example, a health care application of a mobile medical appliance or the like) designated according to attributes of the external electronic device 102 or 104. According to an embodiment of the present disclosure, the application 370 can include an application received from the external electronic apparatus (e.g., the server 106, or the electronic apparatus 102 or 104). According to an embodiment of the present disclosure, the application 370 can include a preloaded application or a third party application which can be downloaded from the server. Names of the elements of the program module 310, according to the above-described embodiments of the present disclosure, can change depending on the type of OS.

According to various embodiments of the present disclosure, at least some of the program module 310 can be implemented in software, firmware, hardware, or a combination of two or more thereof. At least some of the program module 310 can be implemented (e.g., executed) by, for example, the processor (e.g., the processor 210). At least some of the program module 310 can include, for example, a module, a program, a routine, a set of instructions, and/or a process for performing one or more functions.

The term “module” as used herein can, for example, mean a unit including one of hardware, software, and firmware or a combination of two or more of them. The “module” can be interchangeably used with, for example, the term “unit”, “logic”, “logical block”, “component”, or “circuit”. The “module” can be a minimum unit of an integrated component element or a part thereof. The “module' can be a minimum unit for performing one or more functions or a part thereof. The “module” can be mechanically or electronically implemented. For example, the “module” according to the present disclosure can include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure can be implemented by a command stored in a computer-readable storage medium in a programming module form. The instruction, when executed by a processor (e.g., the processor 120), can cause the one or more processors to execute the function corresponding to the instruction. The computer-readable storage medium can be, for example, the memory 130.

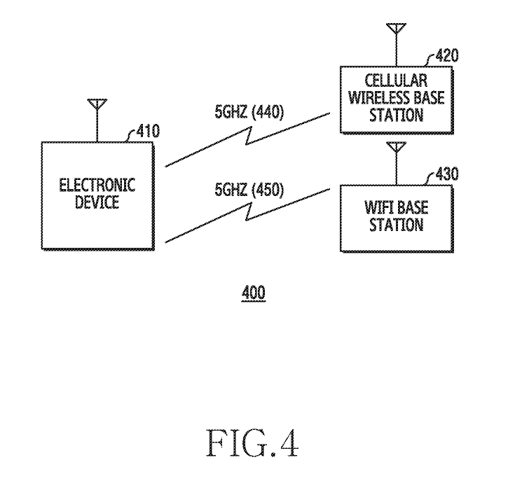

FIG. 4 is a diagram illustrating a network environment 400 that includes an electronic device using two different communication protocols in the same band according to various embodiments of the present disclosure.

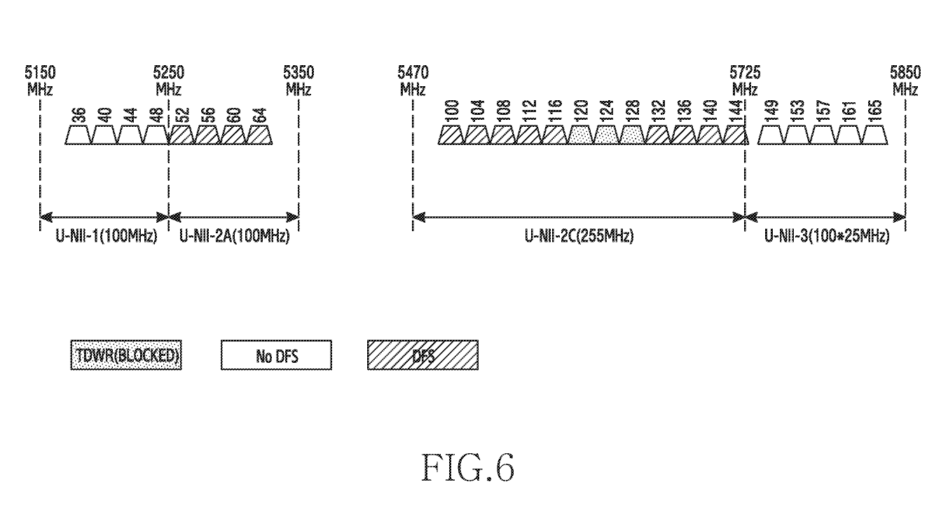

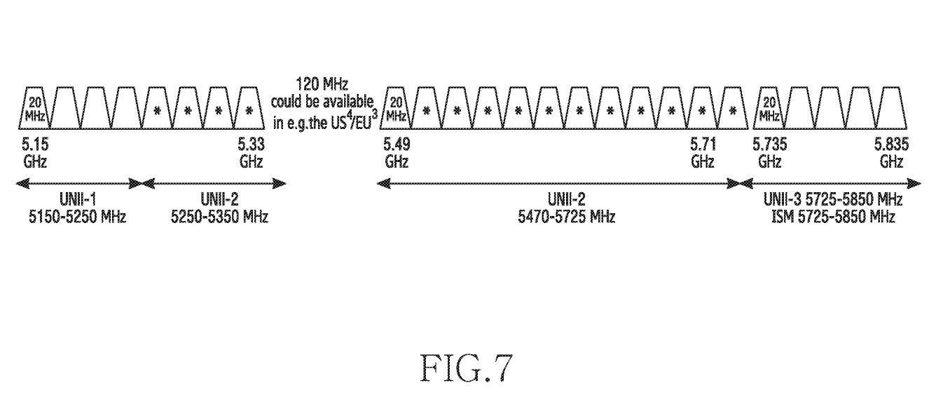

Referring to FIG. 4, the electronic device 410, according to various embodiments, can communicate with a Wi-Fi base station (or Access Point (AP)) 430 based on a Wi-Fi communication protocol or an IEEE 802.11 protocol that uses channels 450 of the 5 GHz band, or can communicate with a cellular wireless base station (or eNode-B, Node-B, etc.) 420 based on a Long Term Evolution (LTE) communication protocol that uses channels 440 of the 5 GHz band. FIG. 6 below illustrates channels defined in the 5 GHz band for a Wi-Fi communication scheme, and FIG. 7 below illustrates channels defined in the 5 GHz band for an LTE communication scheme.

In a case in which two different communication protocols are combined, an electronic device in the related art separately uses an antenna of the 5 GHz band for a Wi-Fi communication scheme that uses channels of the 5 GHz band. However, the number of antennas can increase when the antenna of the 5 GHz band is separately used for the Wi-Fi communication scheme.

In general, an electronic device shares one antenna using a Single Pole Double Throw (SPDT) switch constituting two physical RF paths in order to minimize the number of antennas. In this case, a problem can arise in which a complicated algorithm is implemented on account of a difference in standard between two different communication protocols (e.g., scan timing, priority, etc.), or it is impossible to simultaneously transmit and receive two signals depending on the different communication protocols. In other words, operating times according to the different communication protocols are separated from each other in time so that the electronic device cannot transmit and receive the two signals depending on the different communication protocols.

Additionally, when a measurement or scan is conducted using a switch for the coexistence of the different protocols, it can take more than twice as much time to conduct the measurement or scan.

Particularly, in one-to-n communication, it is necessary to control a switching operation between two protocols, and the number of control pins (e.g., General Radio Frequency Centers (GRFCs)) and current consumption of a processor can increase for the control.

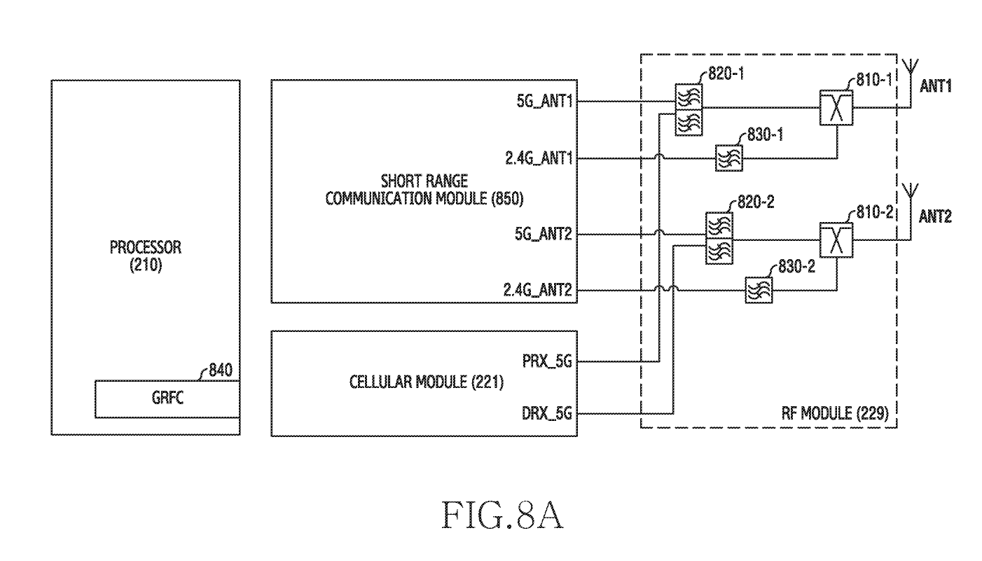

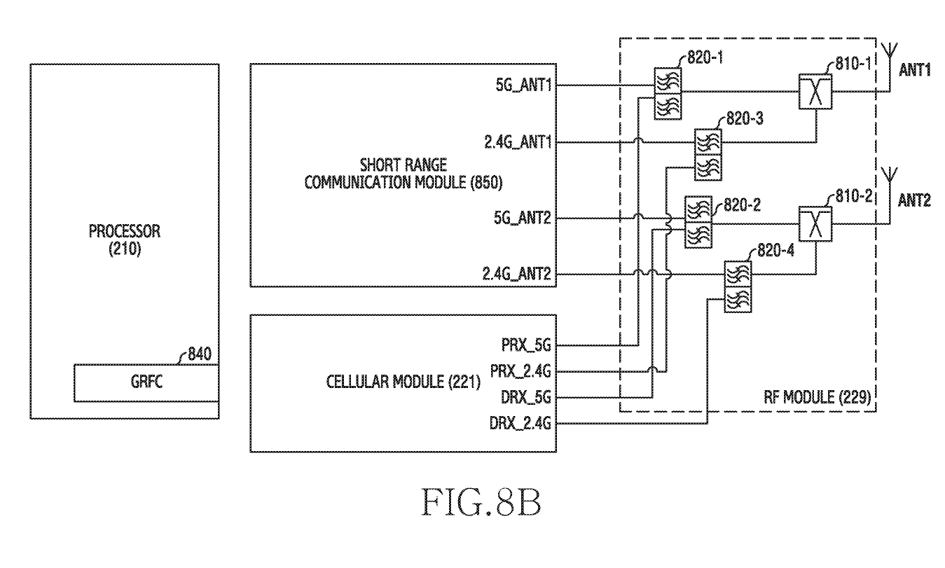

Various embodiments of the present disclosure can provide a passive element as in FIGS. 8A and 8B below, or can provide an antenna sharing structure that uses a combination of a passive element and an SPDT switch as in FIGS. 9A and 9B below in a case in which two different communication protocols are used.

The electronic device 410, according to one embodiment, can include a main antenna and a sub-antenna (e.g., a diversity/MIMO antenna). The main antenna and the sub-antenna can constitute separate RF paths.

According to one embodiment, as illustrated in FIGS. 8A and 8B below, an antenna sharing structure can share an antenna using a passive element for the first RF path corresponding to the main antenna and a passive element for the second RF path corresponding to the sub-antenna.

According to one embodiment, as illustrated in FIGS. 9A and 9B below, an antenna sharing structure can share an antenna using a passive element for the first RF path corresponding to the main antenna and an SPDT switch for the second RF path corresponding to the sub-antenna.

Various embodiments of the present disclosure can also be applied to the 3.5 GHz unlicensed band, without being limited to the 5GHz band.

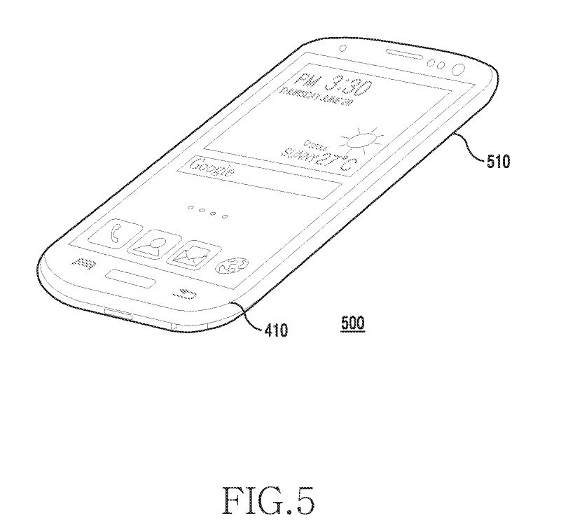

FIG. 5 is a perspective view 500 illustrating the electronic device that includes a housing according to various embodiments of the present disclosure.

Referring to FIG. 5, the electronic device 410 can have the housing 510 that forms the external appearance thereof, and the elements of the electronic device described above with reference to FIG. 2 can be accommodated in the receiving space of the housing 510. In addition, a display can be provided on a first surface of the housing 510, and a battery cover can be provided on a second surface of the housing 510. The electronic device 410 can include a plurality of antennas, and the antennas can be mounted in different positions. For example, a first portion of the housing 510 can form a first antenna, and a second portion of the housing 510 can form a second antenna. Alternatively, the first antenna can be provided in the housing so as to be located near the first portion of the housing 510, and the second antenna can be provided in the housing so as to be located near the second portion of the housing 510.

FIG. 6 illustrates channelization used by Wi-Fi of the 5GHz band according to various embodiments of the present disclosure.

Referring to FIG. 6, the frequency band used by Wi-Fi can be divided into Unlicensed National Information Infrastructure (UNII)-1 ranging from 5.15 GHz to 5.25 GHz, UNII-2A ranging from 5.25 GHz to 5.35 GHz, UNII-2C ranging from 5.47 GHz to 5.725 GHz, and UNII-3 ranging from 5.725 GHz to 5.850 GHz.

A total of 25 channels (CH 36, CH 40, CH 44, CH48, CH52, CH56, CH60, CH64, CH100, CH104, CH108, CH112, CH116, CH120, CH124, CH128, CH132, CH136, CH140, CH144, CH149, CH153, CH157, CH161, and CH165) can be allocated to Wi-Fi in the 5GHz band, and the minimum channel bandwidth of each channel can be 20 MHz.

Each channel has a center frequency that represents the center frequency of the channel bandwidth (20 MHz) thereof. CH36, CH40, CH44, and CH48 have center frequencies of 5.18 GHz, 5.20 GHz, 5.22 GHz, and 5.24 GHz. CH52, CH56, CH60, and CH64 have center frequencies of 5.26 GHz, 5.28 GHz, 5.30 GHz, and 5.32 GHz. Further, CH100, CH104, CH108, CH112, CH116, CH120, CH124, CH128, CH132, CH136, CH140, CH144, CH149, CH153, CH157, CH161, and CH165 can have center frequencies of 5.50 GHz, 5.52 GHz, 5.54 GHz, 5.56 GHz, 5.58 GHz, 5.60 GHz, 5.62 GHz, 5.64 GHz, 5.66 GHz, 5.68 GHz, 5.70 GHz, 5.72 GHz, 5.745 GHz, 5.765 GHz, 5.785 GHz, 5.805 GHz, and 5.825 GHz.

A Dynamic Frequency Selection (DFS) function is not supported for CH36, CH40, CH44, CH48, CH149, CH153, CH157, CH161, and CH165, but is supported for CH52, CH56, CH60, CH64, CH100, CH104, CH108, CH112, CH116, CH132, CH136, CH140, and CH144. CH120, CH124, and CH128 can be limited to the purpose for a Terminal Doppler Weather Radar (TDWR).

FIG. 7 illustrates channelization used by LTE of the 5GHz band according to various embodiments of the present disclosure.

Referring to FIG. 7, the frequency band used by LTE can be divided into UNII-1 ranging from 5.15 GH to 5.25 GHz, UNII-2 ranging from 5.25 GHz to 5.725 GHz, and UNII-3 ranging from 5.725 GHz to 5.585 GHz. For reference, the Federal Communications Commission (FCC) in the USA currently restricts the use of the 5.35-5.470 GHz segment and the 5.59-5.65 GHz segment in the UNII-2. In the LTE system, the band defined for the UNII-1 spectrum is band 252, the band defined for the UNII-2 spectrum is bands 253 and 254, and the band defined for the UNII-3 spectrum is bands 254 and 255. Each channel in the LTE system can have a bandwidth of 1.4 MHz to 20 MHz.

The channels used in the LTE system can be distinguished from each other by their bands and EUTRA Absolute Radio Frequency Channel Numbers (RARFCNs). Table 1 below lists LTE channels used in the 5 GHz band.

TABLE 1

| | | FREQUENCY |
|---|---|---|
| BAND | EARFCN | [MHz] |
| 252 | 255244 | 5160 |
| 252 | 255444 | 5180 |
| 252 | 255644 | 5200 |
| 252 | 255844 | 5220 |
| 252 | 246044 | 5240 |
| 255 | 261094 | 5745 |
| 255 | 261294 | 5765 |
| 255 | 261494 | 5785 |
| 255 | 261694 | 5805 |
| 255 | 261894 | 5825 |

As described above, in the 5 GHz band, Wi-Fi channels and LTE channels can exist within a range of 5.15 GHz to 5.850 GHz. The Wi-Fi channels can at least partially be the same as the LTE channels in terms of the center frequencies indicated thereby, only differing in the defined channel names. For example, Wi-Fi CH 36, Wi-Fi CH 40, Wi-Fi CH 44, Wi-Fi CH 48, Wi-Fi CH 149, Wi-Fi CH 153, Wi-Fi CH 157, Wi-Fi CH 161, and Wi-Fi CH 165 can correspond to LTE EARFCN 255444, LTE EARFCN 255644, LTE EARFCN 255844, LTE EARFCN 246044, LTE EARFCN 261094, LTE EARFCN 261294, LTE EARFCN 261494, LTE EARFCN 261694, and LTE EARFCN 261894, respectively.

Although the Wi-Fi communication channels and the LTE communication channels exist within the range of 5.150 GHz to 5.850 GHz, when the electronic device in FIG. 5 uses channels to perform communication with a Wi-Fi base station and an LTE base station, the electronic device can be configured to use channels in which the center frequencies of the Wi-Fi communication channels differ from those of the LTE communication channels. For example, since the center frequencies of Wi-Fi CH36 and LTE EARFCN 255444 are 5.18 GHz, the electronic device cannot use WI-Fi CH36 and LTE EARFCN 255444 at the same time. According to one embodiment, when the electronic device performs Wi-Fi communication using Wi-Fi CH36, the electronic device can perform LTE communication using at least one other LTE communication channel other than LTE EARFCN 255444.

FIGS. 8A and 8B are block diagrams of electronic devices according to various embodiments of the present disclosure.

Referring to FIG. 8A, an electronic device can include a processor 210, a short range communication module 850, a cellular module 221, and an RF module 229. The short range communication module 850 can include at least one of a Wi-Fi module 223 and a Bluetooth module 225.

The RF module 229 can include a first antenna ANT1, a second antenna ANT2, diplexers 810 (e.g., a first diplexer 810-1 and a second diplexer 810-2), a first filter 830-1, a second filter 830-2, signal dividers/signal combiners 820 (a first signal divider/signal combiner 820-1 and a second signal divider/signal combiner 820-2). Although not illustrated, the RF module 229 can further include elements, such as a power amplifier and a Low Noise Amplifier (LNA), etc. Herein, the first antenna ANT1 can be a primary antenna, and the second antenna ANT2 can be a diversity/MIMO antenna. For example, the second antenna ANT2 can be used as a MIMO antenna while performing Wi-Fi communication through the short range communication module 850, or as a diversity or MIMO antenna while performing LTE communication through the cellular module 221.

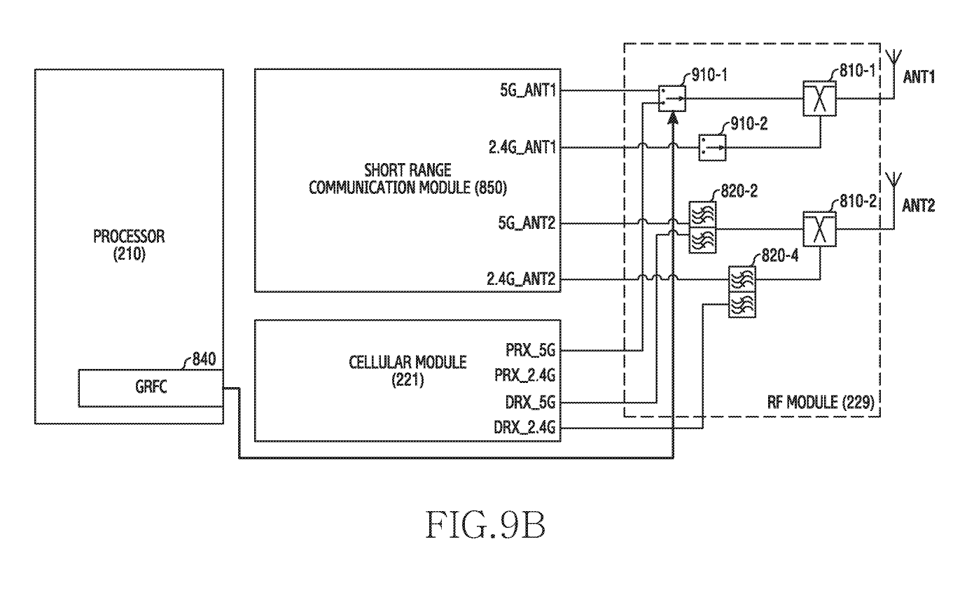

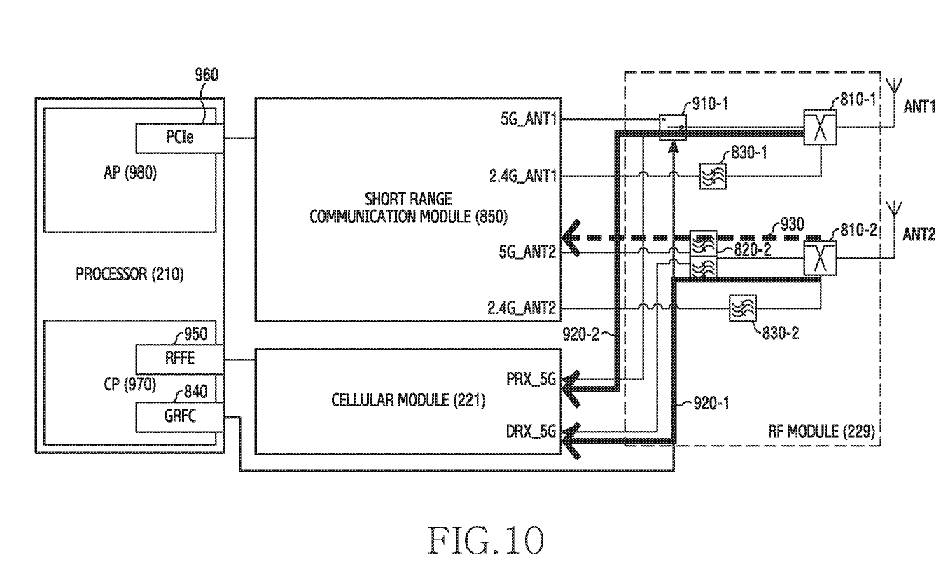

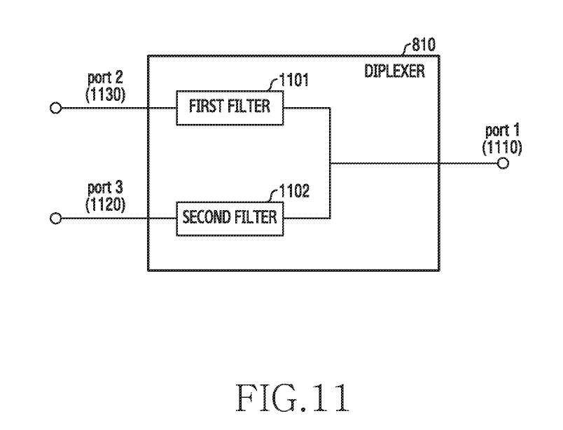

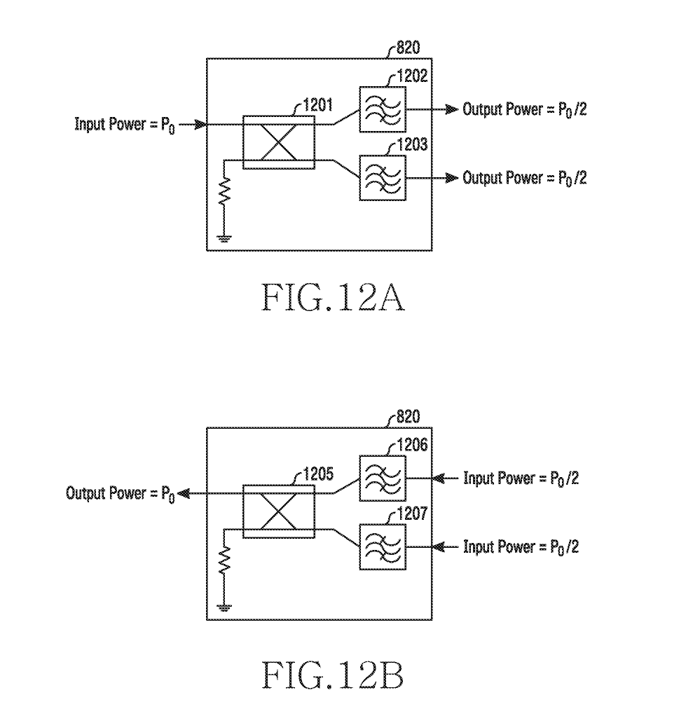

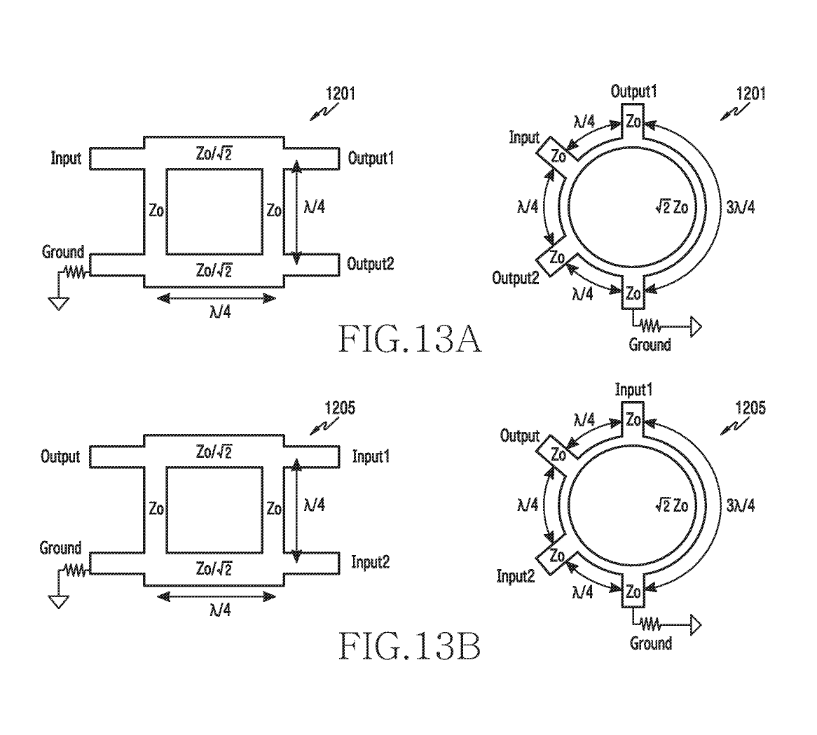

The first antenna ANT1 can constitute a first RF path, and the second antenna ANT2 can constitute a second RF path. Furthermore, the first RF path can be divided into two paths by the first diplexer 810-1, and one of the two paths can be divided into two paths by the first signal divider/signal combiner 820-1. Likewise, the second RF path can be divided into two paths by the second diplexer 810-2, and one of the two paths can be divided into two paths by the second signal divider/signal combiner 820-2. The first diplexer 810-1 and the second diplexer 810-2 divide signals of two bands (e.g., 2.4 GHz and 5 GHz bands), and the first signal divider/signal combiner 820-1 and the second signal divider/signal combiner 820-2 do not divide signals according to bands, but simply divide one input signal into two equivalent output signals. FIG. 11 below is referred to for the structures of the first diplexer 810-1 and the second diplexer 810-2, and FIGS. 12A to 13B are referred to for the structures of the first signal divider/signal combiner 820-1 and the second signal divider/signal combiner 820-2.

According to one embodiment, the first antenna ANT1 can be electrically connected with a first terminal of the first diplexer 810-1 and can provide a received signal to the first diplexer 810-1. For example, the first antenna can provide a signal of the 5 GHz band and a signal of the 2.4 GHz band to the first diplexer 810-1. The signal of the 5 GHz band can include at least one of a Wi-Fi signal and an LTE signal. When receiving the signal of the 5 GHz band and the signal of the 2.4 GHz from the first antenna, the first diplexer 810-1 can isolate the received signals and can output the signal of the 5 GHz band and the signal of the 2.4 GHz to the first signal divider/signal combiner 820-1 and the first filter 830-1, respectively. For example, the signal of the 2.4 GHz band received from the first antenna can be output to the first filter 830-1 through a second terminal of the first diplexer 810-1, and the signal of the 5 GHz received from the first antenna can be output to the first signal divider/signal combiner 820-1 through a third terminal of the first diplexer 810-1. During a transmission operation, the first diplexer 810-1 can combine a signal of the 5 GHz band transferred from the cellular module 221 and/or the short range communication module 850 through the first signal divider/signal combiner 820-1 and a signal of the 2.4 GHz band transferred from the short range communication module 850 through the first filter 830-1, and can output the combined signals to the first antenna ANT1. For instance, the signal of the 2.4 GHZ band transferred from the short range communication module 850 through the second terminal of the first diplexer 810-1 can be output to the first antenna ANT1 through the first terminal of the first diplexer 810-1, and the signal of the 5 GHz band transferred from the cellular module 221 and/or the short range communication module 850 through the third terminal of the first diplexer 810-1 can be output to the first antenna ANT1 through the first terminal of the first diplexer 810-1. When receiving the signal of the 2.4 GHz from the second terminal of the first diplexer 810-1, the first filter 830-1 can filter the received signal and can output the filtered signal to the short range communication module 850. Furthermore, during a transmission operation, the first filter 830-1 can filter a signal of the 2.4 GHz band transferred from the short range communication module 850 and can output the filtered signal to the second terminal of the first diplexer 810-1. When receiving the signal of the 5GHz through the third terminal of the first diplexer 810-1, the first signal divider/signal combiner 820-1 can divide the received signal and can output the signals divided from each other to the cellular module 221 and the short range communication module 850 at the same time. The signal of the 5GHz band received through the third terminal of the first diplexer 810-1 can be a Wi-Fi signal, an LTE signal, or a signal in which a Wi-Fi signal and an LTE signal overlap each other. During a transmission operation, the first signal divider/signal combiner 820-1 can combine signals of the 5 GHz band transferred from the cellular module 221 and/or the short range communication module 850 and can output the combined signals to the third terminal of the first diplexer 810-1.

In the same way, the second antenna ANT2 can be electrically connected with a first terminal of the second diplexer 810-2 and can provide a received signal to the second diplexer 810-2. For example, the second antenna can provide a signal of the 5 GHz band and a signal of the 2.4 GHz band to the second diplexer 810-2. The signal of the 5 GHz band can include a Wi-Fi signal and an LTE signal. When receiving the signal of the 5 GHz band and the signal of the 2.4 GHz from the second antenna ANT2, the second diplexer 810-2 can isolate the received signals and can output the signal of the 5 GHz band and the signal of the 2.4 GHz to the second signal divider/signal combiner 820-2 and the second filter 830-2, respectively. For example, the signal of the 2.4 GHz band received from the second antenna can be output to the second filter 830-2 through a second terminal of the second diplexer 810-2, and the signal of the 5 GHz received from the second antenna can be output to the second signal divider/signal combiner 820-2 through a third terminal of the second diplexer 810-2. During a transmission operation, the second diplexer 810-2 can combine a signal of the 5 GHz band transferred from the cellular module 221 and/or the short range communication module 850 through the second signal divider/signal combiner 820-2 and a signal of the 2.4 GHz band transferred from the short range communication module 850 through the second filter 830-2, and can output the combined signals to the second antenna ANT2. For instance, the signal of the 2.4 GHZ band transferred from the short range communication module 850 through the second terminal of the second diplexer 810-2 can be output to the second antenna ANT2 through the first terminal of the second diplexer 810-2, and the signal of the 5 GHz band transferred from the cellular module 221 and/or the short range communication module 850 through the third terminal of the second diplexer 810-2 can be output to the second antenna ANT2 through the first terminal of the second diplexer 810-2. When receiving the signal of the 2.4 GHz from the second terminal of the second diplexer 810-2, the second filter 830-2 can filter the received signal and can output the filtered signal to the short range communication module 850. Furthermore, during a transmission operation, the second filter 830-2 can filter a signal of the 2.4 GHz band transferred from the short range communication module 850 and can output the filtered signal to the second terminal of the second diplexer 810-2. When receiving the signal of the 5GHz through the third terminal of the second diplexer 810-2, the second signal divider/signal combiner 820-2 can divide the received signal and can output the signals divided from each other to the cellular module 221 and the short range communication module 850 at the same time. The signal of the 5GHz band received through the third terminal of the second diplexer 810-2 can be a Wi-Fi signal, an LTE signal, or a signal in which a Wi-Fi signal and an LTE signal overlap each other. During a transmission operation, the second signal divider/signal combiner 820-2 can combine signals of the 5 GHz band transferred from the cellular module 221 and/or the short range communication module 850 and can output the combined signals to the third terminal of the second diplexer 810-2.

When receiving the divided signal of the 5 GHz band from the first signal divider/signal combiner 820-1 or the second signal divider/signal combiner 820-2, the cellular module 221 can convert the received signal into a baseband signal based on a corresponding communication scheme (e.g., an LTE communication protocol) and can transfer the converted baseband signal to the processor 210.

The processor 210 may not decode the converted baseband signal in a case where the converted baseband signal is not an LTE signal, but can decode the converted baseband signal in a case where the converted baseband signal is an LTE signal.

In various embodiments, in a case where the signals of the 5 GHz band divided from each other include a Wi-Fi signal corresponding to a first channel and an LTE signal corresponding to a second channel, the processor 210 can remove the Wi-Fi signal corresponding to the first channel from the signals of the 5 GHz band divided from each other and can then decode the LTE signal.

The short range communication module 850 can include at least one processor 210. When receiving the divided signal of the 5 GHz band from the first signal divider/signal combiner 820-1 or the second signal divider/signal combiner 820-2, the short range communication module 850 can decode the received signal based on a corresponding communication scheme (e.g., a Wi-Fi communication protocol). The short range communication module 850 may not decode the divided signal of the 5 GHz band in a case where the divided signal of the 5GHz is not a Wi-Fi signal, but can decode the divided signal of the 5 GHz band in a case where the divided signal of the 5 GHz is a Wi-Fi signal.

In various embodiments, in a case where the divided signal of the 5 GHz band includes a Wi-Fi signal corresponding to the first channel and an LTE signal corresponding to the second channel, the short range communication module 850 can remove the LTE signal, which corresponds to the second channel, from the divided signal of the 5 GHz band and can then decode the Wi-Fi signal. The short range communication module 850 can transfer the decoded result to an application processor (not illustrated). In one embodiment, an LTE signal and a Wi-Fi signal can be shared in the 5 GHz band as in FIG. 8A, and an LTE signal and a Wi-Fi signal can be shared both in the 2.4 GHz band and in the 5 GHz band as in FIG. 8B.

The configuration of the electronic device of FIG. 8B is similar to that of the electronic device of FIG. 8A. Meanwhile, in an RF module 229, the first filter 830-1 and the second filter 830-2 of FIG. 8A can be replaced by a third signal divider/signal combiner 820-3 and a fourth signal divider/signal combiner 820-4. The third signal divider/signal combiner 820-3 can divide a signal of the 2.4 GHz band received from a first antenna ANT1 and can simultaneously output the signals divided from each other to a cellular module 221 and a short range communication module 850, or can combine signals of the 2.4 GHz band transferred from the cellular module 221 and/or the short range communication module 850 and can output the combined signals to a first diplexer 810-1. The fourth signal divider/signal combiner 820-4 can divide a signal of the 2.4 GHz band received from a second antenna ANT2 and can simultaneously output the signals divided from each other to the cellular module 221 and the short range communication module 850, or can combine signals of the 2.4 GHz band transferred from the cellular module 221 and/or the short range communication module 850 and can output the combined signals to a second diplexer 810-2.

Since the operations of the third signal divider/signal combiner 820-3 and the fourth signal divider/signal combiner 820-4 are the same as those of the first signal divider/signal combiner 820-1 and the second signal divider/signal combiner 820-2, differing only in the operating band, reference is made to the first signal divider/signal combiner 820-1 and the second signal divider/signal combiner 820-2.

Further, similar to the short range communication module 850, the cellular module 221 can include a plurality of ports to process signals of the 2.4 and 5 GHz bands. For example, a port PRX_5 G of the cellular module 221 can be used to transmit and/or receive LTE signals of the 5 GHz band through the first antenna ANT1, and a port DRX_5 G of the cellular module 221 can be used to transmit and/or receive LTE signals of the 5 GHz band through the second antenna ANT2. In addition, a port PRX_2.4 G of the cellular module 221 can be used to transmit and/or receive LTE signals of the 2.4 GHz band through the first antenna ANT1, and a port DRX_2.4 G of the cellular module 221 can be used to transmit and/or receive LTE signals of the 2.4 GHz band through the second antenna ANT2.

According to one embodiment, the 2.4 GHz band can be an unlicensed band, and the 5 GHz band can be a licensed band.

Meanwhile, in FIGS. 8A and 8B, one signal of the 5 GHz band is divided through the first signal divider/signal combiner 820-1 on the first RF path or the second signal divider/signal combiner 820-2 on the second RF path such that the signals divided from each other are simultaneously output to the cellular module 221 and the short range communication module 850, or two signals of the 5 GHz band from the cellular module 221 and the short range communication module 850 are combined and output. Accordingly, a control pin (GRFC) 840 for separately controlling a switch in the processor 210 is not required. For example, it is not necessary to transmit and receive a Wi-Fi signal and an LTE signal of the 5 GHz band by controlling a switch.

FIGS. 9A and 9B are block diagrams of electronic devices according to various embodiments of the present disclosure.

Referring to FIG. 9A, an electronic device can be the same as the electronic device of FIG. 8A. Meanwhile, in FIG. 9A, a switch 910 can be provided on a first RF path corresponding to a first antenna ANT1, instead of the first signal divider/signal combiner 820-1.

The switch 910 can output an LTE signal of the 5 GHz band to a cellular module 221 and a Wi-Fi signal of the 5 GHz band to a short range communication module 850 according to a control signal transferred through a control pin (GRFC) 840 of a processor 210. For example, the switch 910 can output an input signal to the cellular module 221 when the input signal is an LTE signal of the 5 GHz band, and can output an input signal to the short range communication module 850 when the input signal is a Wi-Fi signal of the 5 GHz band. Furthermore, the switch 910 can output, to the first antenna ANT1, an LTE signal of the 5 GHz band from the cellular module 221 or a Wi-Fi signal of the 5 GHz band from the short range communication module 850 according to a control signal transferred through the control pin (GRFC) 840 of the processor 210.

Referring to FIG. 9B, an electronic device can be the same as the electronic device of FIG. 8B. Meanwhile, in FIG. 9B, a first switch 910-1 and a second switch 910-2 can be provided on a first RF path corresponding to a first antenna ANT1, instead of the first signal divider/signal combiner 820-1 and the third signal divider/signal combiner 820-3. The first switch 910-1 can be the same as the switch 910 of FIG. 9A. Further, the second switch 910-2 can be the same as the first switch 910-1, differing only in the operating band. For example, the first switch 910-1 can operate in the 5 GHz band, and the second switch 910-2 can operate in the 2.4 GHz band.

According to another embodiment, in FIG. 8B, a third switch 910-3 (not illustrated) and a fourth switch 910-4 (not illustrated) can be provided on the second RF path corresponding to the second antenna ANT2, instead of the second signal divider/signal combiner 820-2 and the fourth signal divider/signal combiner 820-4. The third switch 910-3 (not illustrated) and the fourth switch 910-4 (not illustrated) can perform the same operations as those of the first switch 910-1 and the second switch 910-2 of FIG. 9B. Meanwhile, the third switch 910-3 (not illustrated) and the fourth switch 910-4 (not illustrated) can be connected with the second antenna ANT2 through the second diplexer 810-2, and the first switch 910-1 and the second switch 910-2 of FIG. 9B can be connected with the first antenna ANT1 through the first diplexer 810-1.

According to yet another embodiment, in FIG. 8B, the first switch 910-1 can be provided on the first RF path corresponding to the first antenna ANT1, instead of the first signal divider/signal combiner 820-1, and the third switch 910-3 (not illustrated) can be provided on the second RF path corresponding to the second antenna ANT2, instead of the second signal divider/signal combiner 820-2.

According to yet another embodiment, in FIG. 8B, the second switch 910-2 can be provided on the first RF path corresponding to the first antenna ANT1, instead of the third signal divider/signal combiner 820-3, and the fourth switch 910-4 (not illustrated) can be provided on the second RF path corresponding to the second antenna ANT2, instead of the fourth signal divider/signal combiner 820-4.

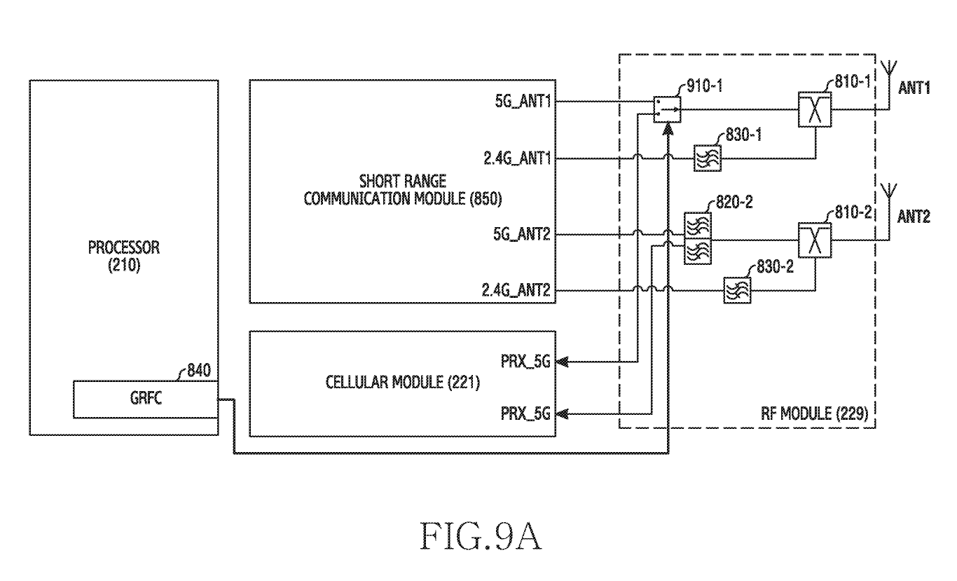

FIG. 10 is a block diagram of an electronic device according to an embodiment of the present disclosure.

Referring to FIG. 10, the electronic device has a configuration that is the same as that of the electronic device of FIG. 9A.

In FIG. 10, a first RF path corresponding to a first antenna ANT1 can receive a Wi-Fi signal of the 5 GHz band in a first time slot and an LTE signal of the 5 GHz band in a second time slot through a switch 910. Further, a second RF path corresponding to a second antenna ANT2 can simultaneously receive a Wi-Fi signal of the 5 GHz band and an LTE signal of the 5 GHz band through a second signal divider/signal combiner 820-2.

In FIG. 10, one antenna (e.g., the first antenna ANT1) can only use one communication protocol (e.g., LTE) through the switch 910, and the other antenna (e.g., the second antenna ANT2) can simultaneously use two communication protocols (e.g., LTE and Wi-Fi) through the second signal divider/signal combiner 820-2. In FIG. 10, a complicated algorithm for the coexistence of two different communication protocols (LTE and Wi-Fi) can be simplified. For example, during LTE communication of the 5 GHz band, the first antenna ANT1 can operate as a primary receiver through the switch 910 (920-1), and the second antenna ANT2 can operate as a diversity receiver for LTE communication through the second signal divider/signal combiner 820-2 (920-2) and can simultaneously perform a background scan operation 930 for Wi-Fi communication.

According to one embodiment, the LTE communication can be performed through an RF Frontend Interface (RFFE) interface 950 of a Communication Processor (CP) 970 in a processor 210, and the background scan operation 930 for the Wi-Fi communication can be controlled through a Peripheral Component Interconnect express (PCIe) interface 960 of an Application Processor (AP) 980 in the processor 210. Further, the switch 910 can control the path of a transmitted and/or received signal through a GRFC interface 840 of the CP 970 in the processor 210. The RFFE interface 950 can deliver a baseband signal between the CP 970 and a cellular module 221, and the PCIe interface 960 can deliver data between the AP 980 and a short range communication module 850.

While the switch 910 is described as an SPDT switch and based on a GRFC control module in various embodiments of the present disclosure, the switch 910 is not limited to the SPDT switch and the GRFC control module.

In various embodiments of the present disclosure, the signal divider/signal combiner 820-2 can function to connect one RF signal to two different paths. For example, the signal divider/signal combiner 820 is designed for sharing between a Wi-Fi protocol and an LTE protocol that have the same band of 5 GHz, but can be implemented in the 3.5 GHz unlicensed band, without being limited to the 5 GHz band.

An antenna sharing structure using a switch with an active structure is advantageous in that the insertion loss is small, and the antenna sharing structures of FIGS. 8A and 8B are advantageous in that it is not necessary to control a switch, and control is simple. Further, the hybrid antenna sharing structures of FIGS. 9A and 9B have the advantages of active and passive structures so that the most efficient structural design is possible. Table 2 below lists switching operations for an active structure only using a switch, a passive structure only using a passive element, and a hybrid structure in which an active structure and a passive structure are combined. In Table 2 below, Wi-Fi communication can have a priority higher than that of LTE communication.

TABLE 2

| Antenna | | Switch | | Passive | | Hybrid | |
|---|---|---|---|---|---|---|---|
| configuration | | (Prior Art) | | (1in2out Filter) | | ANT1 | ANT2 |
| Wi-Fi | LTE | ANT1 | ANT2 | ANT1 | ANT2 | (1in2out) | (Switch) |
| Standby | Not | Wi-Fi | Wi-Fi | Wi-Fi + | Wi-Fi + LTE | Wi-Fi + LTE | Wi-Fi |
| | Conf. | | | LTE | | | |
| Standby | Configured | Wi-Fi | Wi-Fi/LTE | Wi-Fi + | Wi-Fi + LTE | Wi-Fi + LTE | Wi-Fi/LTE |
| | | | | LTE | | | |
| Not | Configured | LTE | LTE | Wi-Fi + | Wi-Fi + LTE | Wi-Fi + LTE | LTE |
| Turn on | | | | LTE | | | |
| Connect | Configured | Wi-Fi | Wi-Fi | Wi-Fi + | Wi-Fi + LTE | Wi-Fi + LTE | Wi-Fi |
| | | | | LTE | | | |
| Standby | Connect | LTE | Wi-Fi/LTE | Wi-Fi + | Wi-Fi + LTE | Wi-Fi + LTE | LTE |
| | | | | LTE | | | |
| Connect | Connect | Wi-Fi | Wi-Fi | Wi-Fi + | Wi-Fi + LTE | Wi-Fi + LTE | Wi-Fi |
| | | | | LTE | | | |

| | | | |
|---|---|---|---|
| Note | Wi-Fi/LTE: Two | Wi-Fi + LTE: Two | ANT1 is always |
| | paths are switched | paths are always | connected to two different |
| | in tune-away | connected to Wi-Fi | protocols, and ANT2 is |
| | scheme. | and LTE. | connected to one protocol |
| | | | or switched in tune-away |
| | | | scheme according to ANT |
| | | | configuration. |

The terms “Standby” and “configured” refer to a state in which communication is activated, but there is no traffic transmission, the term “connect” refers to a state in which communication is activated, and there is traffic transmission, and the terms “not turn on” and “not configured” refer to a state in which communication is deactivated. The term “'tune-away” can generally indicate discontinuity in which an access terminal fails to receive service from a serving access point or a serving sector while the access terminal is receiving pilot signals from another access point or sector. For example, in a case of using a switch, while Wi-Fi communication stands by and LTE communication is not configured, the first antenna ANT1 and the second antenna ANT2 are all configured for the Wi-Fi communication; while Wi-Fi communication stands by and LTE communication is configured, ANT1 is configured for the Wi-Fi communication, and ANT2 is alternately switched for the LTE communication and the Wi-Fi communication; while Wi-Fi communication is not turned on and LTE communication is configured, ANT1 and ANT2 are all configured for LTE communication; while Wi-Fi communication is connected and LTE communication is configured, ANT1 and ANT2 are all configured for the Wi-Fi communication; while Wi-Fi communication stands by and LTE communication is connected, ANT1 is configured for the LTE communication, and ANT2 is alternately switched for the LTE communication and the Wi-Fi communication; and while Wi-Fi communication is connected and LTE communication is connected, ANT1 and ANT2 are all configured for the Wi-Fi communication.

In various embodiments, in a case of using a passive element (e.g., a signal divider, a 1in2out filter, etc.), ANT1 and ANT2 can all be connected for Wi-Fi communication and LTE communication regardless of the states of the LTE communication and the Wi-Fi communication.

In various embodiments, in a case of a hybrid antenna sharing structure (that is, in a case where ANT1 is connected with a passive element (e.g., a signal divider, a 1in2out filter, etc.) and ANT2 is connected to an active element (e.g., an SPDT switch)), ANT1 can be connected to two different communication protocols for Wi-Fi communication and LTE communication regardless of the states of the LTE communication and the Wi-Fi communication.

In addition, while Wi-Fi communication stands by and LTE communication is not configured for ANT2, ANT2 can be configured for the Wi-Fi communication; while Wi-Fi communication stands by and LTE communication is configured for ANT2, ANT2 can be alternately switched for the LTE communication and the Wi-Fi communication; while Wi-Fi communication is not turned on and LTE communication is configured, ANT2 can be configured for the LTE communication; while Wi-Fi communication is connected and LTE communication is configured, ANT2 can be configured for the Wi-Fi communication; while Wi-Fi communication stands by and LTE communication is connected, ANT2 can be configured for the LTE communication; and while Wi-Fi communication is connected and LTE communication is connected, ANT2 can be configured for the Wi-Fi communication.

FIG. 11 is a detailed block diagram of a diplexer of an electronic device according to an embodiment of the present disclosure.

Referring to FIG. 11, the diplexer 810 can be constituted by a first filter and a second filter. The first filter 1101 can be a High Pass Filter (HPF), and the second filter 1102 can be a Low Pass Filter (LPF). For example, the first filter can pass a signal of the 5 GHz band, and the second filter can pass a signal of the 2.4 GHz band.

According to various embodiments of the present disclosure, the diplexer 810 can constitute the first diplexers 810-1 or the second diplexers 810-2 of FIGS. 8A to 10.

A first port 1110 of the diplexer 810 can be electrically connected with an antenna. A second port 1130 of the diplexer 810 can be electrically connected with the second port (e.g., 2.4 G_ANT1 of FIG. 8A) of the short range communication module 850. A third port 1120 of the diplexer 810 can be electrically connected with the first port (e.g., 5 G_ANT1 of FIG. 8A) of the short range communication module 850 and the third port (e.g., PRX_5 of FIG. 8A) of the cellular module 221 through a signal divider/signal combiner.

FIG. 12A is a detailed block diagram of a signal divider of an electronic device according to an embodiment of the present disclosure.

Referring to FIG. 12A, the signal divider 820 can include a coupler 1201, a first filter 1202, and a second filter 1203.

According to various embodiments of the present disclosure, the signal divider 820 can constitute the first signal divider/signal combiner 820-1, the second signal divider/signal combiner 820-2, the third signal divider/signal combiner 820-3, or the fourth signal divider/signal combiner 820-4 of FIGS. 8A to 10.

The coupler 1201 divides one input signal (e.g., an LTE signal, a Wi-Fi signal, or a signal in which an LTE signal and a Wi-Fi signal overlap each other) to output the same to the first filter 1202 and the second filter 1203. According to one embodiment, the first filter 1202 can be a filter for processing an LTE signal, and the second filter 1203 can be a filter for processing a Wi-Fi signal. For example, the second filter 1203 can filter the Wi-Fi 5 GHz band defined in FIG. 6, and the first filter 1202 can filter the LTE 5 GHz band defined in FIG. 7. The frequency characteristics of the first and second filters 1202 and 1203 can be the same as each other in that the first and second filters have pass bands of 5.15 GHz to 5.85 GHz.

If the power of an input signal is P0, the output power of the first filter 1202 can be P0/2, and the output power of the second filter 1203 can be P0/2.

FIG. 12B is a detailed block diagram of a signal combiner of an electronic device according to an embodiment of the present disclosure.

Referring to FIG. 12B, the signal combiner 820 can include a coupler 1205, a third filter 1206, and a fourth filter 1207.

The coupler 1205 combines two input signals (e.g., an LTE signal and a Wi-Fi signal) from the third and fourth filters 1206 and 1207 and outputs, to an antenna, one signal into which the two input signals combine. The third filter 1206 is a filter for processing an LTE signal, and the fourth filter 1207 is a filter for processing a Wi-Fi signal. For example, the third filter 1206 can filter channel signals of the Wi-Fi 5 GHz band defined in FIG. 6, and the fourth filter 1207 can filter channel signals of the LTE 5 GHz band defined in FIG. 7. The frequency characteristics of the third and fourth filters 1206 and 1207 can be the same as each other in that the third and fourth filters have pass bands of 5.15 GHz to 5.85 GHz, and can be the same as the frequency characteristics of the first and second filters 1202 and 1203.

If a first input signal is input to the first filter 1202 and a second input signal is input to the second filter 1203, the first and second input signals can be combined and then output to an antenna. The filters can cause additional insertion losses.

FIG. 13A illustrates a coupler of a signal divider according to an embodiment of the present disclosure.

Referring to FIG. 13A, the coupler 1201 can be implemented as a quadrature hybrid coupler or a ring hybrid coupler.

The quadrature hybrid coupler can include one input terminal, two output terminals, and one ground terminal. The distance between the first and second output terminals and the distance between the input terminal and the ground terminal are □/4, and the impedance is Z0. Further, the distance between the input terminal and the first output terminal and the distance between the ground terminal and the second output terminal are □/4, and the impedance is . The quadrature hybrid coupler has a phase difference of 90 degrees between a signal of the first output terminal and a signal of the second output terminal.

The ring hybrid coupler can include one input terminal, one ground terminal, and two output terminals. Each terminal has an impedance of Z0. The distance between the first output terminal and the input terminal, the distance between the input terminal and the second output terminal, the distance between the second output terminal and the ground terminal are □/4, the distance between the first output terminal and the ground terminal is 3□/4, and the impedance is. The ring hybrid coupler has a phase difference of 180 degrees between a signal of the first output terminal and a signal of the second output terminal.

FIG. 13B illustrates a coupler of a signal combiner according to an embodiment of the present disclosure.

Referring to FIG. 13B, the coupler 1205 can be implemented as a quadrature hybrid coupler or a ring hybrid coupler.

The quadrature hybrid coupler can include two input terminals, one output terminal, and one ground terminal. The distance between the first and second input terminals and the distance between the output terminal and the ground terminal are λ/4, and the impedance is Z0. Further, the distance between the first input terminal and the output terminal and the distance between the second input terminal and the ground terminal are λ/4, and the impedance is Z0/\sqrt{2}. The quadrature hybrid coupler has a phase difference of 90 degrees between a signal of the first input terminal and a signal of the second input terminal.

The ring hybrid coupler can include two input terminals, one ground terminal, and one output terminal. Each terminal has an impedance of Z0. The distance between the first input terminal and the first output terminal, the distance between the first output terminal and the second input terminal, the distance between the second input terminal and the ground terminal are λ/4, the distance between the first input terminal and the ground terminal is 3λ/4, and the impedance is Z0/\sqrt{2}. The ring hybrid coupler has a phase difference of 180 degrees between a signal of the first input terminal and a signal of the second input terminal.

In various embodiments, an electronic device can include: a housing; a first antenna configured to form a first portion of the housing or located in the housing so as to be adjacent to the first portion of the housing; a first communication circuit that includes a first port and a second port, the first port being used to transmit and/or receive a first signal of a first frequency band and the second port being used to transmit and/or receive a second signal of a second frequency band lower than the first frequency band; a second communication circuit that includes a third port used to transmit and/or receive a third signal of a third frequency band at least partially overlapping the first frequency band; and a first diplexer that includes first to third terminals, the first terminal being electrically connected with the first antenna, the second terminal being electrically connected with the second port of the first communication circuit, and the third terminal being electrically connected with the first port of the first communication circuit and the third port of the second communication circuit through at least one first signal divider/signal combiner.

The at least one first signal divider/signal combiner can include a first coupler or a first divider configured to divide one input signal to output two identical output signals.

The at least one first signal divider/signal combiner can further include: a first filter configured to pass a frequency band supported by a first communication scheme; and a second filter configured to pass a frequency band supported by a second communication scheme.

The electronic device can further include a second antenna configured to form a second portion of the housing or located in the housing so as to be adjacent to the second portion of the housing. The first communication circuit can further include a fourth port and a fifth port, the fourth port being used to transmit and/or receive the first signal of the first frequency band and the fifth port being used to transmit and/or receive the second signal of the second frequency band lower than the first frequency band. The second communication circuit can further include a sixth port used to transmit and/or receive the third signal of the third frequency band at least partially overlapping the first frequency band. The electronic device can further include a second diplexer that includes first to third terminals, the first terminal being electrically connected with the second antenna, the second terminal being electrically connected with the fifth port of the first communication circuit, and the third terminal being electrically connected with the fourth port of the first communication circuit and the sixth port of the second communication circuit through at least one second signal divider/signal combiner.

The at least one second signal divider/signal combiner can include a second coupler or a second divider configured to divide one input signal to output two identical output signals.

The at least one second signal divider/signal combiner can further include: a fifth filter configured to pass a frequency band supported by a first communication scheme; and a sixth filter configured to pass a frequency band supported by a second communication scheme.

The electronic device can further include a second antenna configured to form a second portion of the housing or located in the housing so as to be adjacent to the second portion of the housing. The first communication circuit can further include a fourth port and a fifth port, the fourth port being used to transmit/receive the first signal of the first frequency band and the fifth port being used to transmit/receive the second signal of the second frequency band lower than the first frequency band. The second communication circuit can further include a sixth port used to transmit/receive the third signal of the third frequency band at least partially overlapping the first frequency band. The electronic device can further include a second diplexer that includes first to third terminals, the first terminal being electrically connected with the second antenna, the second terminal being electrically connected with the fifth port of the first communication circuit, and the third terminal being electrically connected with the fourth port of the first communication circuit and the sixth port of the second communication circuit through at least one switch.

The first communication circuit can operate on the basis of a Wi-Fi communication protocol, and the second communication circuit can operate on the basis of a Long Term Evolution (LTE) communication protocol.

The first and third frequency bands can have a frequency range of 5.15 GHz to 5.85 GHz.

In various embodiments, an electronic device can include: an antenna configured to receive, through a first antenna, at least one of a signal of a first frequency band corresponding to a first communication protocol and a signal of a second frequency band at least partially overlapping the first frequency band and corresponding to a second communication protocol; a signal divider configured to divide one of the signal of the first frequency band and the signal of the second frequency band into two paths; a first communication processor configured to decode the signals divided from each other on the basis of the first communication protocol; and a second communication processor configured to decode the signals divided from each other on the basis of the second communication protocol.

The first communication processor can remove the signal of the second frequency band that is included in the signals divided from each other, and the second communication processor can remove the signal of the first frequency band that is included in the signals divided from each other.

When the signals divided from each other are decoded on the basis of the first communication protocol, the signals divided from each other may not be decoded in a case in which the signals divided from each other are signals of the second frequency band.

When the signals divided from each other are decoded on the basis of the second communication protocol, the signals divided from each other may not be decoded in a case in which the signals divided from each other are signals of the first frequency band.

The first communication protocol can be a Wi-Fi communication protocol, and the second communication protocol can be a Long Term Evolution (LTE) communication protocol.

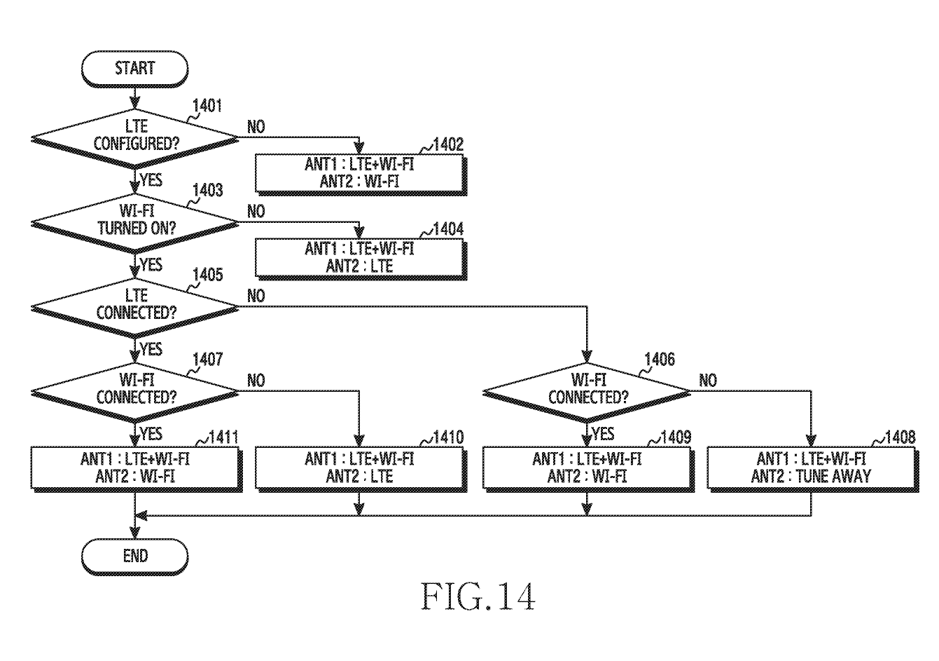

FIG. 14 is a flowchart for an antenna operation of an electronic device according to an embodiment of the present disclosure.

FIG. 14 is a flowchart illustrating the operation of an antenna according to a combination of the states of two different communication protocols in a case in Table 2 above where ANT1 is connected with a passive element (e.g., a signal divider, a lin2out filter, etc.) and ANT2 is connected to an active element (e.g., an SPDT switch) (see FIG. 9).

For example, when it is determined in operation 1401 that LTE communication is not configured, the electronic device can configure ANT1 for LTE communication and Wi-Fi communication and can configure ANT2 for Wi-Fi communication in operation 1402. Operation 1402 can correspond to a case in Table 2 above in which Wi-Fi communication stands by and LTE communication is not configured.

When it is determined in operation 1403 that Wi-Fi communication is not turned on, the electronic device can configure ANT1 for LTE communication and Wi-Fi communication and can configure ANT2 for LTE communication in operation 1404. Operation 1404 can correspond to a case in Table 2 above in which Wi-Fi communication is not turned on and LTE communication is configured.

When it is determined in operation 1405 that LTE communication is connected and when it is determined in operation 1407 that Wi-Fi communication is connected, the electronic device can configure ANT1 for LTE communication and Wi-Fi communication and ANT2 for Wi-Fi communication in operation 1411. Operation 1411 can correspond to a case in Table 2 above in which Wi-Fi communication is connected and LTE communication is connected.

When it is determined in operation 1405 that LTE communication is connected and when it is determined in operation 1407 that Wi-Fi communication is not connected, the electronic device can configure ANT1 for LTE communication and Wi-Fi communication and ANT2 for LTE communication in operation 1410. Operation 1410 can correspond to a case in Table 2 above in which Wi-Fi communication stands by and LTE communication is connected.

When it is determined in operation 1405 that LTE communication is not connected and when it is determined in operation 1406 that Wi-Fi communication is connected, the electronic device can configure ANT1 for LTE communication and Wi-Fi communication and ANT2 for Wi-Fi communication in operation 1409. Operation 1409 can correspond to a case in Table 2 above in which Wi-Fi communication is connected and LTE communication is configured.

When it is determined in operation 1405 that LTE communication is not connected and when it is determined in operation 1406 that Wi-Fi communication is not connected, the electronic device can configure ANT1 for LTE communication and Wi-Fi communication and can alternately switch ANT2 for LTE communication and Wi-Fi communication in operation 1408. Operation 1408 can correspond to a case in Table 2 above in which Wi-Fi communication stands by and LTE communication is configured.

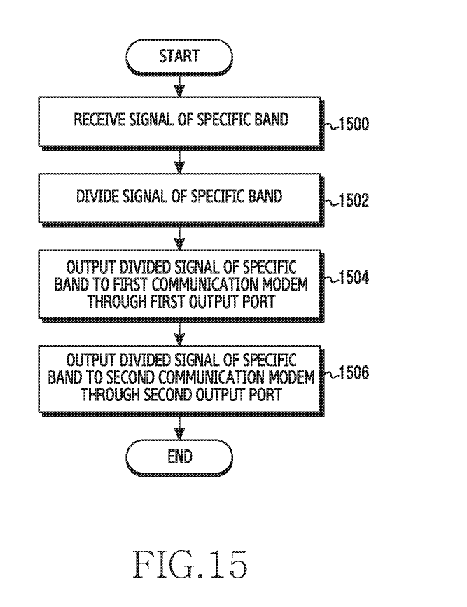

FIG. 15 is a flowchart illustrating the operation of a signal divider of an electronic device according to an embodiment of the present disclosure.

Referring to FIG. 15, the signal divider 820, according to various embodiments, can receive a signal of a specific band through a second port 1130 of a diplexer 810 in operation 1500. The signal of the specific band can be an LTE signal of the 5 GHz band, a Wi-Fi signal of the 5 GHz band, or a signal in which an LTE signal of the 5 GHz band and a Wi-Fi signal of the 5 GHz band overlap each other. The LTE signal of the 5 GHz band and the Wi-Fi signal of the 5 GHz band can be based on channels having different center frequencies.

The signal divider 820, according to various embodiments, can divide the signal of the specific band into two paths in operation 1502. For example, the first path can be connected with a first port 5 G_ANT1 of a short range communication module 850, and the second path can be connected with a third port PRX_5 G of a cellular module 221.

The signal divider 820 can output the divided signal of the specific band to a first communication modem (e.g., the short range communication module 850) through a first output port in operation 1504.

The signal divider 820 can output the divided signal of the specific band to a second communication modem (e.g., the cellular module 221) through a second output port in operation 1506.

Operation 1504 and operation 1506 can be simultaneously performed.

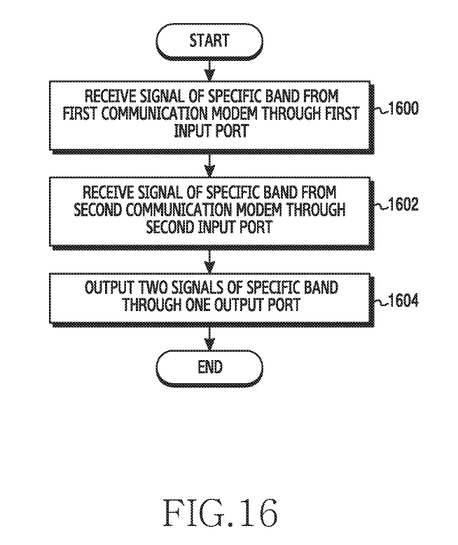

FIG. 16 is a flowchart illustrating the operation of a signal combiner of an electronic device according to an embodiment of the present disclosure.

Referring to FIG. 16, the signal combiner 820, according to various embodiments, can receive a signal of a first specific band from a first communication modem (e.g., the short range communication module 850) in operation 1600. For example, the signal of the first specific band can be a Wi-Fi signal of the 5 GHz band.

The signal combiner 820 can receive a signal of a second specific band from a second communication modem (e.g., the cellular module 221) in operation 1602. For example, the signal of the second specific band can be an LTE signal of the 5 GHz band.

The signal combiner 820 can combine the signal of the first specific band (e.g., a Wi-Fi signal of the 5 GHz band) and the signal of the second specific band (e.g., an LTE signal of the 5 GHz band) to output the combined signals through one output port in operation 1604.

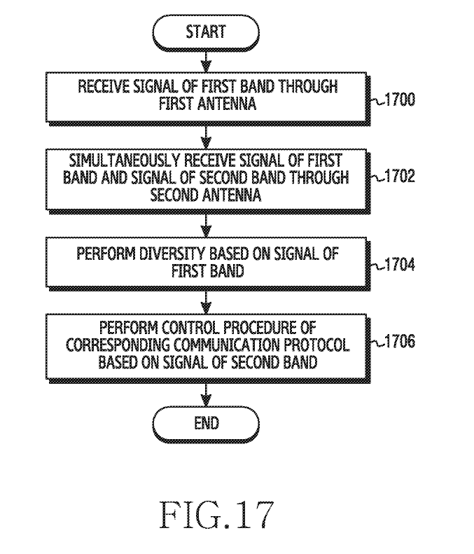

FIG. 17 is a flowchart illustrating a receiving operation of an electronic device according to an embodiment of the present disclosure.

Referring to FIG. 17, the electronic device, according to various embodiments, can receive a signal of a first band through a first antenna in operation 1700 and can simultaneously receive the signal of the first band and a signal of a second band through a second antenna in operation 1702. For example, the signal of the first band can be an LTE signal of the 5 GHz band, and the signal of the second band can be a Wi-Fi signal of the 5 GHz band.

The electronic device can perform diversity using the signal of the first band received through the first antenna and the signal of the first band received through the second antenna based on a first communication scheme in operation 1704. The electronic device can perform a control procedure of a second communication scheme based on the signal of the second band received through the second antenna in operation 1706.

For example, the electronic device can perform a background scan of a Wi-Fi communication protocol based on the signal of the second band received through the second antenna while receiving data using the first antenna and the second antenna based on an LTE communication protocol.

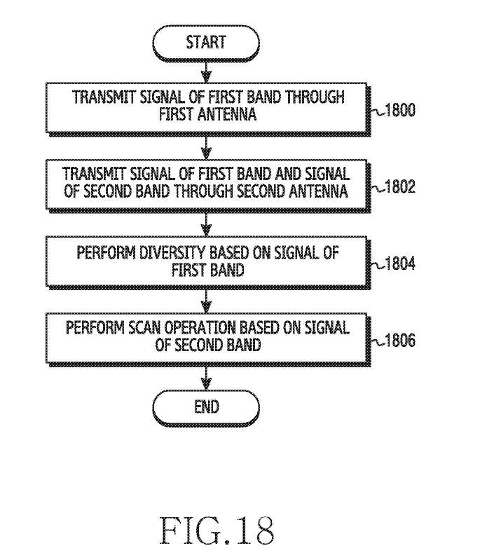

FIG. 18 is a flowchart illustrating a transmitting operation of an electronic device according to an embodiment of the present disclosure.

Referring to FIG. 18, the electronic device, according to various embodiments, can transmit a signal of a first band through a first antenna in operation 1800 and can simultaneously transmit the signal of the first band and a signal of a second band through a second antenna in operation 1802. For example, the signal of the first band can be an LTE signal of the 5 GHz band, and the signal of the second band can be a Wi-Fi signal of the 5 GHz band.

The electronic device can perform diversity by transmitting the signal of the first band through the first antenna and the second antenna based on a first communication scheme in operation 1804.

Furthermore, the electronic device can perform a control procedure of a second communication scheme based on the signal of the second band transmitted through the second antenna in operation 1806.

For example, the electronic device can perform a background scan of a Wi-Fi communication protocol based on the signal of the second band received through the second antenna while transmitting data using the first antenna and the second antenna based on an LTE communication protocol.

In various embodiments, an operating method for an electronic device can include: receiving, through a first antenna, at least one of a signal of a first frequency band corresponding to a first communication protocol and a signal of a second frequency band at least partially overlapping the first frequency band and corresponding to a second communication protocol; dividing at least one of the signal of the first frequency band and the signal of the second frequency band into two paths; decoding the signals divided from each other on the basis of the first communication protocol; and decoding the signals divided from each other on the basis of the second communication protocol.

The operation of decoding the signals divided from each other on the basis of the first communication protocol can further include removing the signal of the second frequency band that is included in the signals divided from each other.

The operation of decoding the signals divided from each other on the basis of the second communication protocol can further include removing the signal of the first frequency band that is included in the signals divided from each other.

When the signals divided from each other are decoded on the basis of the first communication protocol, the signals divided from each other may not be decoded in a case in which the signals divided from each other are signals of the second frequency band.

When the signals divided from each other are decoded on the basis of the second communication protocol, the signals divided from each other may not be decoded in a case in which the signals divided from each other are signals of the first frequency band.

As described above, independent communication between different protocols can be made using an antenna sharing structure that includes a filter that divides one input signal into two output signals and outputs the same. Additionally, communication between different independent protocols is possible at the same time so that the complexity of an algorithm for coexistence can be reduced.

Specifically, since coexistence measurements can be simultaneously made for respective paths, a scan time can be decreased, and a request for priorities between different communication protocols and the complexity of antenna allocation can be reduced.

In addition, a Low Noise Amplifier (LNA) can be added to compensate for an insertion loss caused by using a signal divider/signal combiner (e.g., reference numeral 820) that divides one input signal into two output signals and outputs the same.

As described above, the complexity of switch control for antenna sharing can be reduced by sharing an antenna using a passive element.

Furthermore, switch control according to antenna sharing is not required so that it is possible to reduce the number of control pins and current consumption of a processor.

In addition, by simultaneously using two different communication protocols, it is possible to reduce the complexity of a scan algorithm for the coexistence of the two communication protocols and a scan time.

Embodiments of the present disclosure provided in the present specifications and drawings are merely certain examples to readily describe the technology associated with embodiments of the present disclosure and to help understanding of the embodiments of the present disclosure, but may not limit the scope of the embodiments of the present disclosure. Therefore, in addition to the embodiments disclosed herein, the scope of the various embodiments of the present disclosure should be construed to include all modifications or modified forms drawn based on the technical idea of the various embodiments of the present disclosure.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a housing:
a first antenna configured to form a first portion of the housing or located in the housing so as to be adjacent to the first portion of the housing;
a first communication circuit comprising a first port and a second port, the first port being used to transmit and/or receive a first signal of a first frequency band and the second port being used to transmit and/or receive a second signal of a second frequency band lower than the first frequency band;
a second communication circuit comprising a third port used to transmit and/or receive a third signal of a third frequency band that is at least partially overlapping the first frequency band; and
a first diplexer comprising three terminals, a first terminal being electrically connected with the first antenna, a second terminal being electrically connected with the second port of the first communication circuit, and a third terminal being electrically connected with the first port of the first communication circuit and the third port of the second communication circuit through at least one first signal divider and/or signal combiner.

2. The electronic device of claim 1, wherein the at least one first signal divider and/or signal combiner comprises a first coupler or a first divider configured to divide one input signal to output two identical output signals.

3. The electronic device of claim 2, wherein the at least one first signal divider and/or signal combiner further comprises:
a first filter configured to pass a frequency band supported by a first communication scheme; and
a second filter configured to pass a frequency band supported by a second communication scheme.

4. The electronic device of claim 1, wherein the electronic device further comprises a second antenna configured to form a second portion of the housing or located in the housing so as to be adjacent to the second portion of the housing,
the first communication circuit further comprises a fourth port and a fifth port, the fourth port being used to transmit and/or receive the first signal of the first frequency band and the fifth port being used to transmit and/or receive the second signal of the second frequency band lower than the first frequency band, and
the second communication circuit further comprises a sixth port used to transmit and/or receive the third signal of the third frequency band that is at least partially overlapping the first frequency band,
wherein the electronic device further comprises a second diplexer comprising three terminals, the first terminal being electrically connected with the second antenna, the second terminal being electrically connected with the fifth port of the first communication circuit, and the third terminal being electrically connected with the fourth port of the first communication circuit and the sixth port of the second communication circuit through at least one second signal divider and/or signal combiner.

5. The electronic device of claim 4, wherein the at least one second signal divider and/or signal combiner comprises a second coupler or a second divider configured to divide one input signal to output two identical output signals.

6. The electronic device of claim 5, wherein the at least one second signal divider and/or signal combiner further comprises:
a fifth filter configured to pass a frequency band supported by a first communication scheme; and
a sixth filter configured to pass a frequency band supported by a second communication scheme.

7. The electronic device of claim 1, wherein the electronic device further comprises a second antenna configured to form a second portion of the housing or located in the housing so as to be adjacent to the second portion of the housing,
the first communication circuit further comprises a fourth port and a fifth port, the fourth port being used to transmit and/or receive the first signal of the first frequency band and the fifth port being used to transmit/receive the second signal of the second frequency band lower than the first frequency band, and
the second communication circuit further comprises a sixth port used to transmit/receive the third signal of the third frequency band that is at least partially overlapping the first frequency band,
wherein the electronic device further comprises a second diplexer comprising three terminals, the first terminal being electrically connected with the second antenna, the second terminal being electrically connected with the fifth port of the first communication circuit, and the third terminal being electrically connected with the fourth port of the first communication circuit and the sixth port of the second communication circuit through at least one switch.

8. The electronic device of claim 1, wherein the first communication circuit operates on a basis of a Wi-Fi communication protocol, and the second communication circuit operates on a basis of a Long Term Evolution (LTE) communication protocol.

9. The electronic device of claim 1, wherein the first and third frequency bands comprise a frequency range of 5.15 GHz to 5.85 GHz.

10. An electronic device comprising:
an antenna configured to receive, through a first antenna, at least one of a signal of a first frequency band corresponding to a first communication protocol and a signal of a second frequency band that is at least partially overlapping the first frequency band and corresponding to a second communication protocol;
a signal divider configured to divide one of the signal of the first frequency band and the signal of the second frequency band into two paths;
a first communication processor configured to decode the signals divided from each other based on the first communication protocol; and
a second communication processor configured to decode the signals divided from each other based on the second communication protocol.

11. The electronic device of claim 10, wherein the first communication processor removes the signal of the second frequency band that is included in the signals divided from each other.

12. The electronic device of claim 10, wherein the second communication processor removes the signal of the first frequency band that is included in the signals divided from each other.

13. The electronic device of claim 10, wherein when the signals divided from each other are decoded based on the first communication protocol, the signals divided from each other are not decoded in a case in which the signals divided from each other are signals of the second frequency band.

14. The electronic device of claim 10, wherein when the signals divided from each other are decoded based on the second communication protocol, the signals divided from each other are not decoded in a case in which the signals divided from each other are signals of the first frequency band.

15. The electronic device of claim 10, wherein the first communication protocol is a Wi-Fi communication protocol, and the second communication protocol is a Long Term Evolution (LTE) communication protocol.

16. An operating method for an electronic device, comprising:
receiving, through a first antenna, at least one of a signal of a first frequency band corresponding to a first communication protocol and a signal of a second frequency band that is at least partially overlapping the first frequency band and corresponding to a second communication protocol;
dividing at least one of the signal of the first frequency band and the signal of the second frequency band into two paths;
decoding the signals divided from each other based on the first communication protocol; and
decoding the signals divided from each other based on the second communication protocol.

17. The operating method of claim 16, wherein the decoding of the signals divided from each other based on the first communication protocol further comprises:
removing the signal of the second frequency band that is included in the signals divided from each other.

18. The operating method of claim 16, wherein the decoding of the signals divided from each other based on the second communication protocol further comprises:
removing the signal of the first frequency band that is included in the signals divided from each other.

19. The operating method of claim 16, wherein when the signals divided from each other are decoded based on the first communication protocol, the signals divided from each other are not decoded in a case in which the signals divided from each other are signals of the second frequency band.

20. The operating method of claim 16, wherein when the signals divided from each other are decoded based on the second communication protocol, the signals divided from each other are not decoded in a case in which the signals divided from each other are signals of the first frequency band.
